(19) United States
(12) Patent Application Publication
(10) Pub. No.: US 2017/0004783 A1
(43) Pub. Date: Jan. 5, 2017

(54) IMAGE DISPLAY DEVICE AND DRIVE METHOD THEREFOR

(71) Applicant: Sharp Kabushiki Kaisha, Osaka-shi, Osaka (JP)

(72) Inventor: Tomoyuki Ishihara, Osaka-shi (JP)

(21) Appl. No.: 15/039,906

(22) PCT Filed: Sep. 29, 2014
(86) PCT No.: PCT/JP2014/075791

§ 371 Date: May 27, 2016

(30) Foreign Application Priority Data
Dec. 9, 2013 (JP) 2013-253869

(51) Int. Cl. G09G 3/34; G09G 3/36

(52) U.S. Cl. CPC G09G 3/3413; G09G 3/3607; G09G 3/3688; G09G 2310/0235; G09G 2320/0666; G09G 2320/0233; G09G 2300/0452

(57) ABSTRACT

In an image display device that divides one frame into a plurality of fields and performs drive operation, a light-source lighting period with a sufficient length is ensured. In a field-sequential image display device, as modes during writing of data into pixel portions, a normal writing mode for writing data into one row at a time and a high-speed writing mode for writing data having the same value into a plurality of rows at a time for each column are prepared. In a blue field (F(B)), data writing processing in the high-speed writing mode is performed. In a green field (F(G)) and a red field (F(R)), data writing processing in the normal writing mode is performed.

### TECHNICAL FIELD

The present invention relates to an image display device, and more specifically relates to an image display device that divides one frame into a plurality of fields and performs drive operation, and a drive method for the image display device.

### BACKGROUND ART

There have hitherto been developed a variety of image display devices such as a liquid crystal display device and a plasma display device. Many of liquid crystal display devices, being one kind of the image display devices and capable of performing color display, each include color filters for three colors which allows passage of red (R), green (G) and blue (B) light respectively so as to correspond to three sub-pixels constituting one pixel. However, about two-thirds of backlight light that is applied onto a liquid crystal display panel is absorbed into the color filter, and hence the color-filter liquid crystal display device has a problem of low light utilization efficiency. Therefore, attention has been focused on a field-sequential liquid crystal display device that performs color display without using the color filter.

In the field-sequential system, one frame is typically divided into three fields. For example, a first field is taken as a red field, a second field is taken as a green field, and a third field is taken as a blue field. In the red field, a red screen is displayed by bringing a red light source into a lighted state while writing (writing of data into pixel portions) based on a red component of input image data has been performed. In the green field, a green screen is displayed by bringing a green light source into the lighted state while writing based on a green component of input image data has been performed. In the blue field, a blue screen is displayed by bringing a blue light source into the lighted state while writing based on a blue component of input image data has been performed. The screens of the three colors are repeatedly and sequentially displayed in this manner, and thus, a desired color image is displayed on a display portion. In the field-sequential liquid crystal display device, since the color filter is thus not required, the light utilization efficiency is about three times as high as that of the color-filter liquid crystal display device. Further, the number of pixels in the field-sequential liquid crystal display device can be made, for example, about one-third as large as that in the color-filter liquid crystal display device, thereby enabling an increase in aperture ratio.

Inventions of liquid crystal display devices employing the field-sequential system as described above are disclosed, for example, in Japanese Patent Application Laid-Open Nos. 2013-19921 and 2004-61670. Note that in the liquid crystal display devices disclosed in Japanese Patent Application Laid-Open Nos. 2013-19921 and 2004-61670, data is written into the pixel portions in the same manner in all the fields.

### PRIOR ART DOCUMENTS

### Patent Documents

[Patent Document 1] Japanese Patent Application Laid-Open No. 2013-19921

[Patent Document 2] Japanese Patent Application Laid-Open No. 2004-61670

### SUMMARY OF THE INVENTION

### Problems to be Solved by the Invention

However, the field-sequential liquid crystal display device has a problem that it is difficult to sufficiently ensure a light-source lighting period (a period during which the light source is in the lighted state). This problem is described with reference to FIG. 41. FIG. 41 is a diagram for describing a drive method for a conventional liquid crystal display device employing the field-sequential system. In the example shown in FIG. 41, one frame is divided into a red field F(R), a green field F(G), and a blue field F(B). In FIG. 41, a part denoted by symbol WR represents the manner in which data is written into pixel portions from a top row toward a last row in a display portion, and a part denoted by symbol EM represents that a light source is in the lighted state. Further, in FIG. 41, an arrow denoted by symbol TW represents a period required for writing data in each field (hereinafter referred to as “data writing period”), an arrow denoted by symbol TR represents a period required for liquid crystal to reach a desired state in each field (hereinafter referred to as “liquid crystal response period”), and an arrow denoted by symbol TE represents a light-source lighting period in each field. In the field-sequential liquid crystal display device, it is not sufficient to perform writing of data in each frame, but writing of data has to be performed in each field. That is, data needs to be written at a speed three times as high as the normal speed. Further, in order to correctly display the color, the light source can be brought into the lighted state only after the lapse of the liquid crystal response period TR since the completion of writing of data in the last row. In particular, as the resolution and the size of the device are increased, the data writing period TW becomes longer, and hence the light-source lighting period TE becomes shorter. Accordingly, the number of light sources needs to be increased to ensure sufficient display brightness. Such an increase in number of light sources has been a cause of an increase in cost and an increase in size and weight of the device.

Note that a similar phenomenon also occurs in an image display device other than the liquid crystal display device when one frame is divided into a plurality of fields and drive operation is performed. For example, the similar phenomenon occurs in an image display device employing a time-division gradation system in which gradation display is performed by providing a plurality of fields with mutually different lengths and by controlling a state of each pixel portion (a state of transmission/shielding of light in each pixel portion, or a state of reflection/absorption of light in each pixel portion) in each field. Examples of the image display device employing the time-division gradation system include a ferroelectric liquid crystal display device, a plasma display device, and a DMD projector.

Therefore, an object of the present invention is to ensure a light-source lighting period with a sufficient length in an image display device that divides one frame into a plurality of fields and performs drive operation.

### Means for Solving the Problems

A first aspect of the present invention is directed to an image display device including:
light sources of a plurality of colors; and
pixel portions of a plurality of rows by a plurality of columns that are irradiated with light emitted from the light sources of the plurality of colors,
the image display device configured to display a color image by dividing one frame into a plurality of fields and by switching the color of the light source to be lighted every time the field is switched,
wherein, as modes during writing of data into the pixel portions of the plurality of rows by the plurality of columns, a normal writing mode for writing data into one row at a time and a high-speed writing mode for writing data having the same value into a plurality of rows at a time for each column are prepared, and
data writing processing in the high-speed writing mode is performed in at least one of the fields, and data writing processing in the normal writing mode is performed in the other fields.

According to a second aspect of the present invention, in the first aspect of the present invention,
one frame includes a red field for displaying a red screen, a green field for displaying a green screen, and a blue field for displaying a blue screen, and
in the blue field, the data writing processing in the high-speed writing mode is performed.

According to a third aspect of the present invention, in the second aspect of the present invention,
further in the red field, the data writing processing in the high-speed writing mode is performed.

According to a fourth aspect of the present invention, in the first aspect of the present invention,
one frame includes a red field for displaying a red screen, a green field for displaying a green screen, a blue field for displaying a blue screen, and a white field for displaying a white screen, and
in the white field, the data writing processing in the normal writing mode is performed.

According to a fifth aspect of the present invention, in the first aspect of the present invention,
one frame includes a red field for displaying a red screen, a green field for displaying a green screen, a blue field for displaying a blue screen, and a yellow field for displaying a yellow screen, and
in the yellow field, the data writing processing in the normal writing mode is performed.

According to a sixth aspect of the present invention, in the fifth aspect of the present invention,
the yellow field is provided between the green field and the red field.

According to a seventh aspect of the present invention, in the first aspect of the present invention,
when focusing on a field in which the data writing processing in the high-speed writing mode is performed, a combination of a plurality of rows, into which data having the same value is written, is different between a preceding frame of two consecutive frames and a subsequent frame of the two consecutive frames.

According to an eighth aspect of the present invention, in the first aspect of the present invention,
when a set of rows, into which data is written at the same timing when the data writing processing in the high-speed writing mode is performed, is defined as a group, when the data writing processing in the high-speed writing mode is performed, data having the same value as that of data in a preceding group of two adjacent groups is written into a subsequent group of the two adjacent groups in at least some period of a latter half of a period in which data is written into the preceding group, and
when the data writing processing in the normal writing mode is performed, data having the same value as that of data in a preceding row of two adjacent rows is written into a subsequent row of the two adjacent rows in at least some period of a latter half of a period in which data is written into the preceding row.

A ninth aspect of the present invention is directed to a drive method for an image display device including light sources of a plurality of colors, and pixel portions of a plurality of rows by a plurality of columns that are irradiated with light emitted from the light sources of the plurality of colors, the image display device configured to display a color image by dividing one frame into a plurality of fields and by switching the color of the light source to be lighted every time the field is switched,
the drive method including:
preparing, as modes during writing of data into the pixel portions of the plurality of rows by the plurality of columns, a normal writing mode for writing data into one row at a time and a high-speed writing mode for writing data having the same value into a plurality of rows at a time for each column; and
employing the high-speed writing mode to data writing processing in at least one of the fields, and employing the normal writing mode to data writing processing in the other fields.

A tenth aspect of the present invention is directed to an image display device including:
light sources of a plurality of colors; and
pixel portions of a plurality of rows by a plurality of columns that are irradiated with light emitted from the light sources of the plurality of colors,
the image display device configured to display a color image by dividing one frame into a plurality of fields and by switching the color of the light source to be lighted every time the field is switched,
wherein, in all the fields, data having the same value is written into a plurality of rows at a time for each column, with respect to the pixel portions of the plurality of rows by the plurality of columns.

According to an eleventh aspect of the present invention, in the tenth aspect of the present invention,
one frame includes a red field for displaying a red screen, a green field for displaying a green screen, and a blue field for displaying a blue screen, and
the green field appears a plurality of times within one frame.

According to a twelfth aspect of the present invention, in the eleventh aspect of the present invention,
when focusing on the plurality of times of the green fields that appear within one field, a combination of a plurality of rows, into which data having the same value is written, is different each time of the green field.

According to a thirteenth aspect of the present invention, in the tenth aspect of the present invention,
one frame includes a red field for displaying a red screen, a green field for displaying a green screen, a blue field for displaying a blue screen, and a white field for displaying a white screen, and
the white field appears a plurality of times within one frame.

According to a fourteenth aspect of the present invention, in the tenth aspect of the present invention,
one frame includes a red field for displaying a red screen, a green field for displaying a green screen, a blue field for displaying a blue screen, and a yellow field for displaying a yellow screen, and
the yellow field appears a plurality of times within one frame.

According to a fifteenth aspect of the present invention, in the fourteenth aspect of the present invention,
at least one of the yellow fields that appears the plurality of times within one frame is provided between the green field and the red field.

According to a sixteenth aspect of the present invention, in the tenth aspect of the present invention,
when focusing on at least one field, a combination of a plurality of rows, into which data having the same value is written, is different between a preceding frame of two consecutive frames and a subsequent frame of the two consecutive frames.

According to a seventeenth aspect of the present invention, in the tenth aspect of the present invention,
when a set of rows, into which data is written at the same timing, is defined as a group, data having the same value as that of data in a preceding group of two adjacent groups is written into a subsequent group of the two adjacent groups in at least some period of a latter half of a period in which data is written into the preceding group.

An eighteenth aspect of the present invention is directed to a drive method for an image display device including light sources of a plurality of colors, and pixel portions of a plurality of rows by a plurality of columns that are irradiated with light emitted from the light sources of the plurality of colors, the image display device configured to display a color image by dividing one frame into a plurality of fields and by switching the color of the light source to be lighted every time the field is switched,
the drive method including:
writing, in all the fields, data having the same value into a plurality of rows at a time for each column, with respect to pixel portions of the the plurality of rows by the plurality of columns.

A nineteenth aspect of the present invention is directed to an image display device including:
light sources of a plurality of colors; and
pixel portions of a plurality of rows by a plurality of columns that are irradiated with light emitted from the light sources of the plurality of colors,
the image display device having one frame formed of one or more field groups each including a plurality of fields, and configured to perform gradation display by controlling an on/off state of each of the pixel portions in each of the fields,
wherein, as modes during writing of data into the pixel portions of the plurality of rows by the plurality of columns, a normal writing mode for writing data into one row at a time and a high-speed writing mode for writing data having the same value into a plurality of rows at a time for each column are prepared,
each of the pixel portions is configured such that binary data indicating the on/off state can be written thereinto, and
the high-speed writing mode is employed to data writing processing for display in at least one of the fields, and the normal writing mode is employed to data writing processing for display in the other fields.

According to a twentieth aspect of the present invention, in the nineteenth aspect of the present invention,
one frame includes a red field group for displaying a red screen, a green field group for displaying a green screen, and a blue field group for displaying a blue screen, and
the high-speed writing mode is employed to data writing processing for display in at least one field of the blue field group.

According to a twenty-first aspect of the present invention, in the nineteenth aspect of the present invention,
each of the field groups includes N (N is an integer not smaller than 2) fields having light-source lighting periods with mutually different lengths.

According to a twenty-second aspect of the present invention, in the twenty-first aspect of the present invention,
when focusing on each of the field groups,
   the normal writing mode is employed to data writing processing for display in a field with the first to Kth longest (K is an integer not larger than N−1) light-source lighting period, and the high-speed writing mode is employed to data writing processing for display in the other fields, and
the value of K is the same in all the field groups.

According to a twenty-third aspect of the present invention, in the twenty-first aspect of the present invention,
when focusing on each of the field groups,
   the normal writing mode is employed to data writing processing for display in a field with the first to Kth longest (K is an integer not larger than N−1) light-source lighting period, and the high-speed writing mode is employed to data writing processing for display in the other fields, and
the value of K can be different in each of the field groups.

According to a twenty-fourth aspect of the present invention, in the nineteenth aspect of the present invention,
concerning the data writing processing in the high-speed writing mode for display in at least one field, a combination of a plurality of rows, into which data having the same value is written, is different between a preceding frame of two consecutive frames and a subsequent frame of the two consecutive frames.

A twenty-fifth aspect of the present invention is directed to a drive method for an image display device including light sources of a plurality of colors, and pixel portions of a plurality of rows by a plurality of columns that are irradiated with light emitted from the light sources of the plurality of colors and configured such that binary data indicating an on/off state can be written thereinto, the image display device having one frame formed of one or more field groups each including a plurality of fields having light-source lighting periods with mutually different lengths, and configured to perform gradation display by controlling an on/off state of each of the pixel portions in each of the fields,
the drive method including:
preparing, as modes during writing of data into the pixel portions of the plurality of rows by the plurality of columns, a normal writing mode for writing data into one row at a time and a high-speed writing mode for writing data having the same value into a plurality of rows at a time for each column, and
employing the high-speed writing mode to data writing processing for display in at least one of the fields, and employing the normal writing mode to data writing processing for display in the other fields.

### Effects of the Invention

According to the first aspect of the present invention, data is written into the pixel portions in a plurality of rows at a time in at least one field of the plurality of fields constituting one frame. For this reason, the length of the data writing period in the field in which data is written into the plurality of rows at a time is shorter than before. Hence a relative length of the light-source lighting period with respect to the length of one frame can be made larger than before. In this manner, in the image display device employing the field-sequential system, it is possible to ensure the light-source lighting period with a sufficient length. Therefore, the number of light sources to be installed in the image display device in order to obtain desired display brightness can be made smaller than before. This results in achievement of cost reduction regarding installation of the light source, space saving, weight reduction, and the like.

According to the second aspect of the present invention, in the image display device in which one frame includes the red field, the green field, and the blue field, data is written into the pixel portions in a plurality of rows at a time in the blue field. Since the sensitivity (visibility) of human eyes to blue is typically low, the low resolution of blue data has a small influence on the image quality. This prevents great deterioration in image quality due to data being written into the pixel portions in a plurality of rows at a time in the blue field. According to the above, it is possible to obtain a similar effect to that of the first aspect of the present invention without causing great deterioration in image quality.

According to the third aspect of the present invention, data is written into the pixel portions in a plurality of rows at a time in the red field in addition to the blue field. Hence a relative length of the light-source lighting period with respect to the length of one frame can be made significantly larger than before. Therefore, the number of light sources to be installed in the image display device in order to obtain desired display brightness can be made significantly smaller.

According to the fourth aspect of the present invention, each frame includes the white field. That is, each frame includes the field for displaying the mixed component of the red component, the green component, and the blue component. It is therefore possible to obtain a similar effect to that of the first aspect of the present invention, while suppressing the occurrence of color breakup.

According to the fifth aspect of the present invention, each frame includes the yellow field. That is, each frame includes the field for displaying the mixed component of the red component and the green component. It is therefore possible to obtain a similar effect to that of the first aspect of the present invention, while more effectively suppressing the occurrence of the color breakup.

According to the sixth aspect of the present invention, the yellow field is provided between the green field and the red field, whereby it is possible to obtain a similar effect to that of the first aspect of the present invention, while significantly suppressing the occurrence of the color breakup.

According to the seventh aspect of the present invention, at least two data-writing patterns are provided with respect to the field in which data is written into a plurality of rows at a time. It is therefore possible to obtain a similar effect to that of the first aspect of the present invention, while suppressing the deterioration in image quality.

According to the eighth aspect of the present invention, the data writing period that overlaps between the adjacent groups or rows is provided. During writing of data into each group or each row, in the first-half period, data is written based on data in the preceding group or the preceding row. Normally, data in adjacent groups or rows are often data highly relevant to each other, and hence the first-half period of the data writing period is useful as a preliminary charging period. According to the above, it is possible to make the data writing period as a whole significantly shorter than before without causing the deterioration in image quality. Therefore, the number of light sources to be installed in the image display device in order to obtain desired display brightness can be more reliably made smaller than before.

According to the ninth aspect of the present invention, it is possible to obtain a similar effect to that of the first aspect of the present invention in the drive method for the image display device.

According to the tenth aspect of the present invention, data is written into the pixel portions in a plurality of rows in all the fields. For this reason, the cycle for writing data into the pixel portions is constant irrespective of the position (the position of the row into which data is written) in the screen. Hence, even when a display element does not completely respond such that a desired transmittance is obtained within each field, no difference occurs in attained level with respect to a target transmittance between the upper end and the lower end of the screen. Thus, uniform color display can be performed in the screen irrespective of the response speed of the display element. Further, since data is written into a plurality of rows at a time in each field, the light-source lighting period with a sufficient length is ensured. According to the above, it is possible to achieve cost reduction regarding installation of the light source, space saving, and weight reduction, while enabling uniform color display on the whole screen.

According to the eleventh aspect of the present invention, in the image display device in which one frame includes the red field, the green field, and the blue field, the green field appears a plurality of times within one frame. Hence it is possible to obtain a similar effect to that of the tenth aspect of the present invention, while suppressing the deterioration in image quality due to the low resolution in each green field.

According to the twelfth aspect of the present invention, although the sensitivity (visibility) of the human eyes to green is high, data is written in different patterns sequentially (or alternately) as to the green field. Hence the resolution is simulatively increased, to suppress the deterioration in image quality due to writing of data into a plurality of rows at a time.

According to the thirteenth aspect of the present invention, each frame includes the white field. That is, each frame includes the field for displaying the mixed component of the red component, the green component, and the blue component. It is therefore possible to obtain a similar effect to that of the tenth aspect of the present invention, while suppressing the occurrence of the color breakup.

According to the fourteenth aspect of the present invention, each frame includes the yellow field. That is, each frame includes the field for displaying the mixed component of the red component and the green component. It is therefore possible to obtain a similar effect to that of the tenth aspect of the present invention, while more effectively suppressing the occurrence of the color breakup.

According to the fifteenth aspect of the present invention, the yellow field is provided between the green field and the red field, whereby it is possible to obtain a similar effect to that of the tenth aspect of the present invention, while significantly suppressing the occurrence of the color breakup.

According to the sixteenth aspect of the present invention, at least two data-writing patterns are provided with respect to at least one field. It is therefore possible to obtain a similar effect to that of the tenth aspect of the present invention, while suppressing the deterioration in image quality.

According to the seventeenth aspect of the present invention, the data writing period that overlaps between the adjacent groups is provided. During writing of data into each group, in the first-half period, data is written based on data in the preceding group. Normally, data in adjacent groups are often data highly relevant to each other, and hence the first-half period of the data writing period is useful as a preliminary charging period.

According to the above, it is possible to make the data writing period as a whole significantly shorter than before without causing the deterioration in image quality. Hence it is possible to achieve cost reduction regarding installation of the light source, space saving, and weight reduction, while causing no deterioration in image quality and enabling uniform color display on the whole screen.

According to the eighteenth aspect of the present invention, it is possible to obtain a similar effect to that of the tenth aspect of the present invention in the drive method for the image display device.

According to the nineteenth aspect of the present invention, in the image display device that performs the binary control, data-writing for display in some field is performed in a plurality of rows at a time. Hence a relative length of the light-source lighting period with respect to the length of one frame is larger than before. Therefore, the number of light sources to be installed in the image display device in order to obtain desired display brightness can be made smaller than before. This results in achievement of cost reduction regarding installation of the light source, space saving, weight reduction, and the like.

According to the twentieth aspect of the present invention, in the image display device in which one frame includes the red field group, the green field group, and the blue field group, data-writing for display in some field of the blue field group is performed in a plurality of rows at a time. Since the sensitivity (visibility) of human eyes to blue is typically low, the low resolution of blue data has a small influence on the image quality. This prevents great deterioration in image quality caused by data-writing for display in the blue field being performed in a plurality of rows at a time. According to the above, it is possible to obtain a similar effect to that of the nineteenth aspect of the present invention without causing great deterioration in image quality.

According to the twenty-first aspect of the present invention, in the image display device in which each of the field groups includes N fields having light-source lighting periods with mutually different lengths and which performs the binary control, it is possible to obtain a similar effect to that of the nineteenth aspect of the present invention.

According to the twenty-second aspect of the present invention, in the image display device that performs the binary control, data-writing for display in the field with a relatively small brightness weight is performed in a plurality of rows at a time. Hence it is possible to obtain a similar effect to that of the nineteenth aspect of the present invention without causing great deterioration in image quality.

According to the twenty-third aspect of the present invention, in the image display device that performs the binary control, a field in which data is written into a plurality of rows at a time is determined in consideration of the sensitivity of the human eyes to colors and the brightness weight. Hence it is possible to obtain a similar effect to that of the nineteenth aspect of the present invention, while effectively suppressing the deterioration in image quality.

According to the twenty-fourth aspect of the present invention, at least two data-writing patterns are provided concerning the data writing processing in the high-speed writing mode for display in at least one field. It is therefore possible to obtain a similar effect to that of the nineteenth aspect of the present invention, while suppressing the deterioration in image quality.

According to the twenty-fifth aspect of the present invention, it is possible to obtain a similar effect to that of the nineteenth aspect of the present invention in the drive method for the image display device.

### BRIEF DESCRIPTION OF THE DRAWINGS

FIG. 1 is a diagram for describing a drive method for a field-sequential liquid crystal display device according to a first embodiment of the present invention.

FIG. 2 is a block diagram showing an overall configuration of the liquid crystal display device in the first embodiment.

FIG. 3 is a diagram showing a configuration of frames in the first embodiment.

FIG. 4 is a diagram schematically representing field data for a blue field for one column in an odd-numbered frame in the first embodiment.

FIG. 5 is a diagram schematically representing field data for the blue field for one column in an even-numbered frame in the first embodiment.

FIG. 6 is a diagram schematically representing field data for a green field, and field data for a red field, for one column in the first embodiment.

FIG. 7 is a diagram schematically representing the manner of writing data in a normal writing mode in the first embodiment.

FIG. 8 is a diagram schematically representing the manner of writing data in a first high-speed writing mode in the first embodiment.

FIG. 9 is a diagram schematically representing the manner of writing data in a second high-speed writing mode in the first embodiment.

FIG. 10 is a diagram for describing the illustrations of FIGS. 7 to 9.

FIG. 11 is a diagram for describing transition of the writing mode in the blue field in the first embodiment.

FIG. 12 is a diagram schematically representing another example of the manner of writing data in the first high-speed writing mode in the first embodiment.

FIG. 13 is a diagram schematically representing another example of the manner of writing data in the second high-speed writing mode in the first embodiment.

FIG. 14 is a diagram schematically representing one example of the manner of writing data in a high-speed writing mode in a modified example of the first embodiment.

FIG. 15 is a diagram schematically representing one example of the manner of writing data in the high-speed writing mode in the modified example of the first embodiment.

FIG. 16 is a diagram schematically representing one example of the manner of writing data in the high-speed writing mode in the modified example of the first embodiment.

FIG. 17 is a diagram schematically representing one example of the manner of writing data in the high-speed writing mode in the modified example of the first embodiment.

FIG. 18 is a diagram for describing a drive method for a field-sequential liquid crystal display device according to a second embodiment of the present invention.

FIG. 19 is a diagram showing a principle of occurrence of color breakup.

FIG. 20 is a diagram showing a configuration of frames in a third embodiment of the present invention.

FIG. 21 is a diagram for describing a drive method in the third embodiment.

FIG. 22 is a diagram showing a configuration of frames in a modified example of the third embodiment.

FIG. 23 is a diagram for describing a drive method in the modified example of the third embodiment.

FIG. 24 is a diagram for describing a problem caused by inclusion of a normal writing field and a high-speed writing field in one frame.

FIG. 25 is a diagram for describing the problem caused by inclusion of the normal writing field and the high-speed writing field in one frame.

FIG. 26 is a diagram showing a configuration of frames in a fourth embodiment of the present invention.

FIG. 27 is a diagram for describing a drive method in the fourth embodiment.

FIG. 28 is a diagram showing a configuration of a frame in a fifth embodiment of the present invention.

FIG. 29 is a diagram for describing a drive method in the fifth embodiment.

FIG. 30 is a diagram schematically representing the manner of writing data in the first high-speed writing mode in a sixth embodiment of the present invention.

FIG. 31 is a diagram schematically representing the manner of writing data in the second high-speed writing mode in the sixth embodiment.

FIG. 32 is a diagram schematically representing the manner of writing data in the normal writing mode in the sixth embodiment.

FIG. 33 is a block diagram showing an overall configuration of a DMD projector according to a seventh embodiment of the present invention.

FIG. 34 is a diagram for describing a mirror portion and a latch circuit portion in the seventh embodiment.

FIG. 35 is a diagram showing a configuration of a frame in the seventh embodiment.

FIG. 36 is a diagram for describing a drive method in a conventional DMD projector.

FIG. 37 is a diagram for describing a drive method in the seventh embodiment.

FIG. 38 is a diagram for describing an effect in the seventh embodiment.

FIG. 39 is a diagram for describing a drive method in an eighth embodiment of the present invention.

FIG. 40 is a diagram for describing a drive method in a ninth embodiment of the present invention.

FIG. 41 is a diagram for describing a drive method for a conventional liquid crystal display device employing the field-sequential system.

### MODES FOR CARRYING OUT THE INVENTION

Hereinafter, embodiments of the present invention are described with reference to the attached drawings.

Note that first to sixth embodiments are each described taking a liquid crystal display device as an example, and seventh to ninth embodiments are each described taking a DMD projector as an example.

### 1. First Embodiment

### 1.1 Overall Configuration and Summary of Drive Method

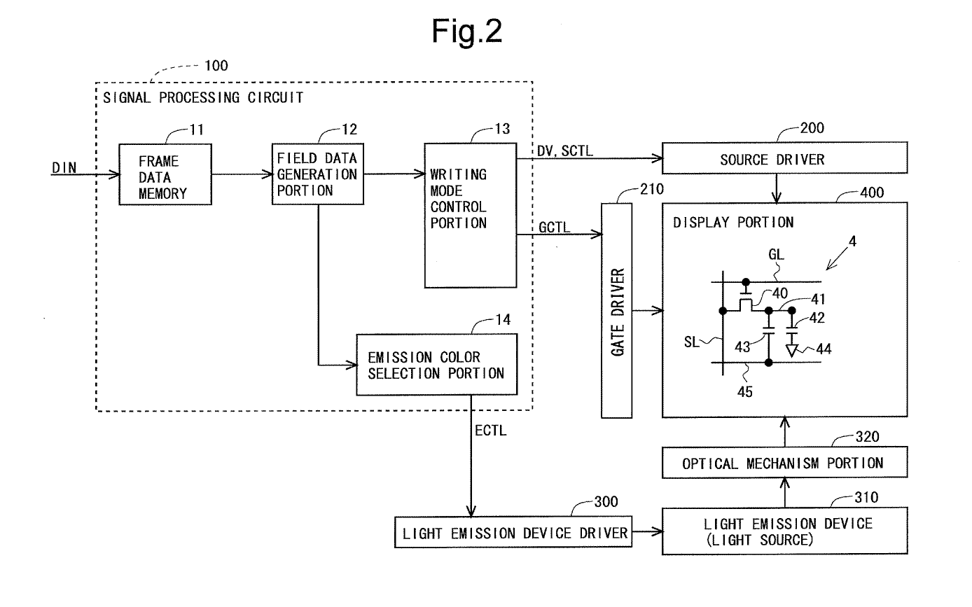

FIG. 2 is a block diagram showing an overall configuration of a field-sequential liquid crystal display device according to a first embodiment of the present invention. This liquid crystal display device is configured by a signal processing circuit 100, a source driver 200, a gate driver 210, a light emission device driver 300, a light emission device (light source) 310, an optical mechanism portion 320, and a display portion 400. The signal processing circuit 100 includes a frame data memory 11, a field data generation portion 12, a writing mode control portion 13, and an emission color selection portion 14. It should be noted that, in the present embodiment, it is assumed that LEDs of three colors (a red

LED, a green LED, and a blue LED) have been employed as the light emission device (light source) 310. A detailed description of each constituent is described later.

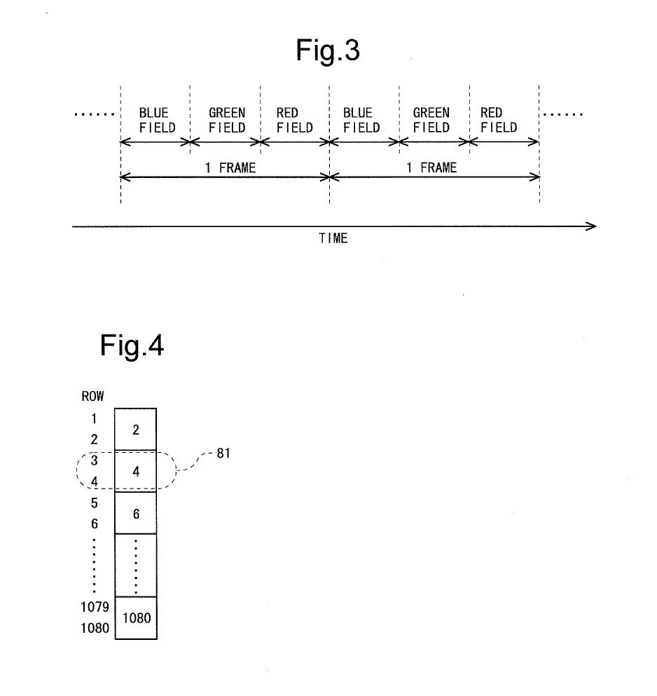

Subsequently, the summary of the drive method in the present embodiment is described. FIG. 3 is a diagram showing a configuration of frames in the present embodiment. Note that FIG. 3 shows a configuration of two frames. The liquid crystal display device according to the present embodiment has employed a field-sequential system. Hence one frame includes a plurality of fields. Specifically, as shown in FIG. 3, one frame includes three fields consisting of a blue field, a green field, and a red field. Note that, in FIG. 3, a length of an arrow representing each field does not represent a length of the time of the field. In the blue field, only the blue LED is brought into a lighted state, and blue display is performed. In the green field, only the green LED is brought into the lighted state, and green display is performed. In the red field, only the red LED is brought into a lighted state, and red display is performed. The frame having such a configuration is repeated during operation of the liquid crystal display device. Note that the order of the three fields is not limited to the order of “the blue field, the green field, and the red field.”

In the present embodiment, data is written into the pixel portions in two rows at a time in only the blue field of the three fields. That is, in the blue field, data having the same value is written into two rows at a time for each column. Hence the data writing period in the blue field is shorter than the data writing period in each of the green field and the red field.

### 1.2 Configuration of Display Portion

In a display portion 400, a plurality of source bus lines (video signal lines) SL and a plurality of gate bus lines (scanning signal lines) GL are provided. In the following description, it is assumed that the number of gate bus lines is 1080. A pixel portion 4 for forming a pixel is provided corresponding to each intersection of the source bus line SL and the gate bus line GL. That is, pixel portions 4 of a plurality of rows by a plurality of columns are included in the display portion 400. Each pixel portion 4 includes: a TFT (thin-film transistor) 40 that is a switching element having a gate terminal connected to the gate bus line GL passing through the corresponding intersection, and having a source terminal connected to the source bus line SL passing through the intersection; a pixel electrode 41 connected to a drain terminal of the TFT 40; a common electrode 44 and an auxiliary capacitance electrode 45 which are commonly provided in the plurality of pixel portions 4; a liquid crystal capacitance 42 formed of the pixel electrode 41 and the common electrode 44; and an auxiliary capacitance 43 formed of the pixel electrode 41 and the auxiliary capacitance electrode 45. The liquid crystal capacitance 42 and the auxiliary capacitance 43 constitute a pixel capacitance. Note that only constituents corresponding to one pixel portion 4 are shown in the display portion 400 in FIG. 2.

Meanwhile, as the TFT 40 in the display portion 400, for example, an oxide TFT (a thin-film transistor using an oxide semiconductor for a channel layer) can be employed. More specifically, as the TFT 40, there can be employed a TFT having a channel layer formed of In—Ga—Zn—O (indium gallium zinc oxide) which is an oxide semiconductor mainly composed of indium (In), gallium (Ga), zinc (Zn), and oxygen (O) (hereinafter referred to as “In—Ga—Zn—O TFT”). Employing such an In—Ga—Zn—O TFT can lead to a higher writing speed than a conventional TFT in addition to obtaining the effects of higher resolution and lower power consumption. Moreover, a transistor using an oxide semiconductor other than In—Ga—Zn—O (indium gallium zinc oxide) for a channel layer can also be employed. For example, a similar effect can be obtained in the case of employing a transistor using, for a channel layer, an oxide semiconductor containing at least one of indium, gallium, zinc, copper (Cu), silicon (Si), tin (Sn), aluminum (Al), calcium (Ca), germanium (Ge), and lead (Pb). Note that the present invention does not intend to exclude the use of a TFT other than the oxide TFT.

### 1.3 Details of Each Constituent

Next, operation of each constituent shown in FIG. 2 is described. Input image data DIN for one frame is stored into the frame data memory 11. Generally, the input image data DIN with about 24 to 72 Hz is inputted from the outside. In contrast, in the field-sequential liquid crystal display device, data is written into each pixel portion at a frequency of not lower than 180 Hz. Due to such a difference in frequency, the input image data DIN is once stored into the frame data memory 11.

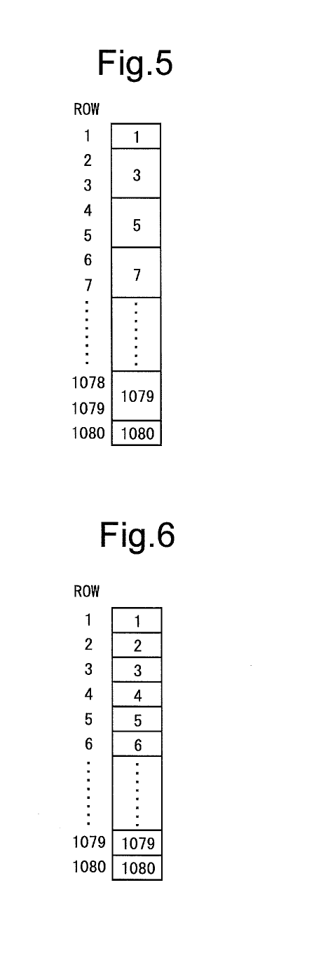

The field data generation portion 12 reads frame data that is data for one frame from the frame data memory 11, and generates field data that is data corresponding to each color based on the frame data. Now, as described above, in the blue field, data is written into the pixel portions 4 in two rows at a time. To achieve this, the field data generation portion 12 generates field data as follows. FIG. 4 is a diagram schematically representing field data for the blue field for one column in an odd-numbered frame. FIG. 5 is a diagram schematically representing field data for the blue field for one column in an even-numbered frame. Note that the odd-numbered frame and the even-numbered frame may be reversed to each other. For example, a part denoted by numeral 81 in FIG. 4 represents that “data originally in a fourth row is written into a third row and the fourth row.” As can be seen from FIG. 4, in the odd-numbered frame, field data for the blue field is generated such that data originally in a (p+1)th row is written into a pth row and the (p+1)th row (here, p is an odd number not smaller than 1 and not larger than 1079). Further, as can be seen from FIG. 5, in the even-numbered frame, field data for the blue field is generated such that data originally in a (q+1)th row is written into a qth row and the (q+1)th row (here, q is an even number not smaller than 2 and not larger than 1078). Note that in the even-numbered frame, data originally in a first row is written into the first row, and data originally in a 1080th row is written into the 1080th row. FIG. 6 is a diagram schematically representing field data for the green field, and field data for the red field, for one column. In the green field and the red field, data is written into the pixel portions 4 in one row at a time, similarly to the conventional technique. Hence in the field data generation portion 12, the field data for the green field and the field data for the red field are generated such that original data is written into each row. In addition, hereinafter, the pattern as shown in FIG. 4 is referred to as a “first pattern”, and the pattern as shown in FIG. 5 is referred to as a “second pattern.”

The writing mode control portion 13 provides the field data generated in the field data generation portion 12 to the source driver 200 as a digital video signal DV. This digital video signal DV is a signal for controlling a time aperture ratio of liquid crystal in each pixel portion 4 in each field. The time aperture ratio corresponds to a temporal integrated value of a transmittance of liquid crystal in the light-source lighting period. Actual display brightness is determined by temporal superposition between the time aperture ratio of the liquid crystal and the light-source lighting period. The writing mode control portion 13 also controls the writing mode during writing of data into the pixel portions 4 in accordance with the field data generated in the field data generation portion 12. In the present embodiment, there are prepared three writing modes which are a “normal writing mode”, a “first high-speed writing mode”, and a “second high-speed writing mode.” The normal writing mode is a mode for writing data into one row at a time, similarly to the conventional technique. The first high-speed writing mode is a mode for writing data into two rows at a time by use of field data in the first pattern (cf. FIG. 4). The second high-speed writing mode is a mode for writing data into two rows at a time by use of field data in the second pattern (cf. FIG. 5). In accordance with these three writing modes, the writing mode control portion 13 provides a source control signal SCTL to the source driver 200, and provides a gate control signal GCTL to the gate driver 210. It should be noted that, hereinafter, the first high-speed writing mode and the second high-speed writing mode are simply collectively referred as a “high-speed writing mode.”

The emission color selection portion 14 selects the color of the LED to be brought into the lighted state in accordance with the field data generated in the field data generation portion 12. The emission color selection portion 14 then provides a light emission control signal ECTL to the light emission device driver 300 in accordance with the selected color.

The source driver 200 receives the digital video signal DV and the source control signal SCTL which are provided from the writing mode control portion 13, and applies driving video signals to the plurality of source bus lines SL provided in the display portion 400.

The gate driver 210 sequentially selectively drives the plurality of gate bus lines GL provided in the display portion 400 based on the gate control signal GCTL provided from the writing mode control portion 13. In the present embodiment, when the writing mode is the normal writing mode, the gate driver 210 selectively drives the gate bus lines GL one by one, and when the writing mode is the high-speed writing mode, the gate driver 210 selectively drives the gate bus lines GL two by two.

The light emission device driver 300 controls a state (lighted/unlighted state) of each LED based on the light emission control signal ECTL provided from the emission color selection portion 14. The states of the LEDs of the three colors as the light emission device 310 are thereby controlled. The display portion 400 is irradiated with light emitted from the light emission device 310 via the optical mechanism portion 320. Note that the optical mechanism portion 320 serves to ensure the uniformity of in-plane brightness and a color distribution. As the optical mechanism portion 320, for example, a light guide plate is employed.

By each constituent operating as described above, the display state of the screen is switched in each field, and a color image based on the input image data DIN is displayed on the display portion 400.

### 1.4 Drive Method

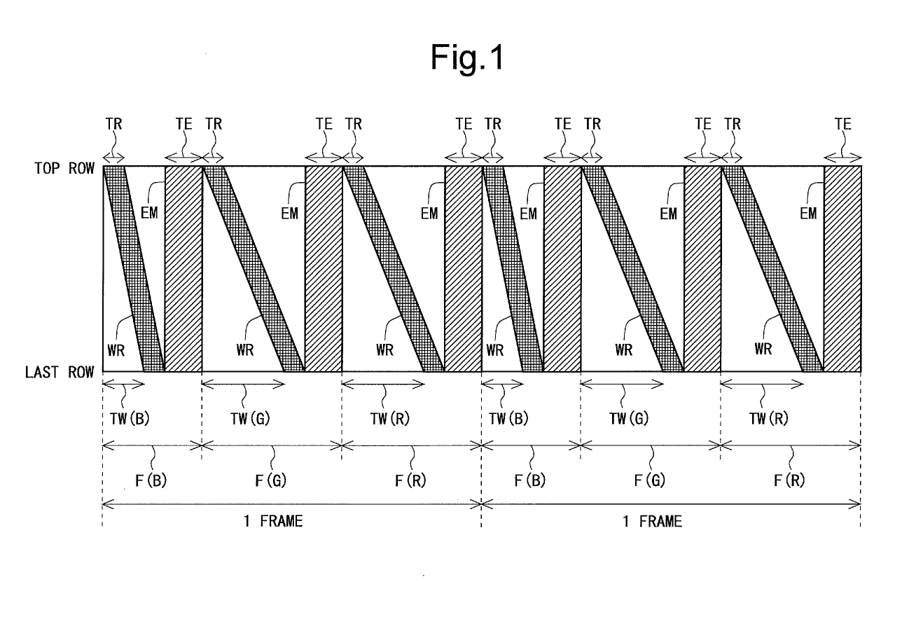

Next, the drive method in the present embodiment is described. FIG. 1 is a diagram for describing the drive method in the present embodiment. As described above, one frame is divided into the blue field F(B), the green field F(G), and the red field F(R). In each of the fields, data is written into the pixel portions 4 from the top row to the last row. Then, in each field, a light-source lighting period TE is provided after the lapse of the liquid crystal response period TR from the end time point of writing data in the last row.

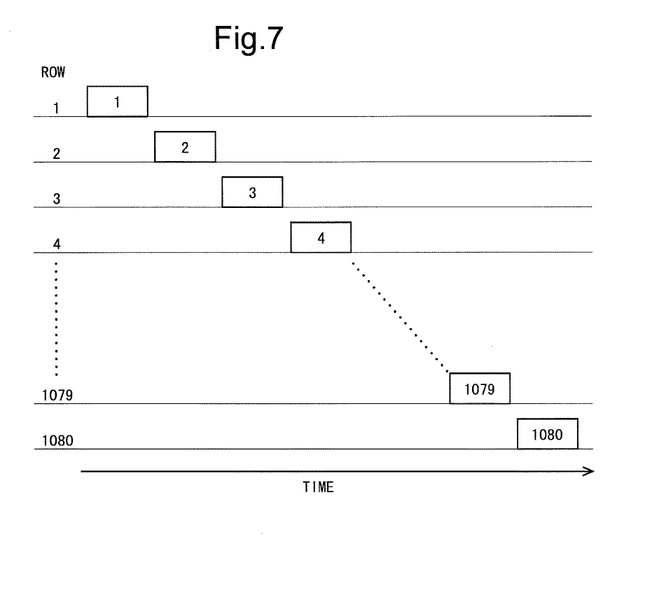

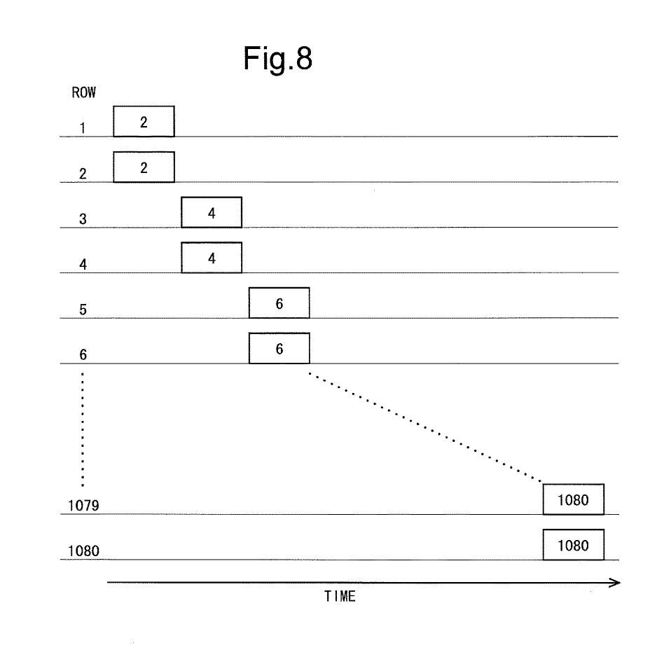

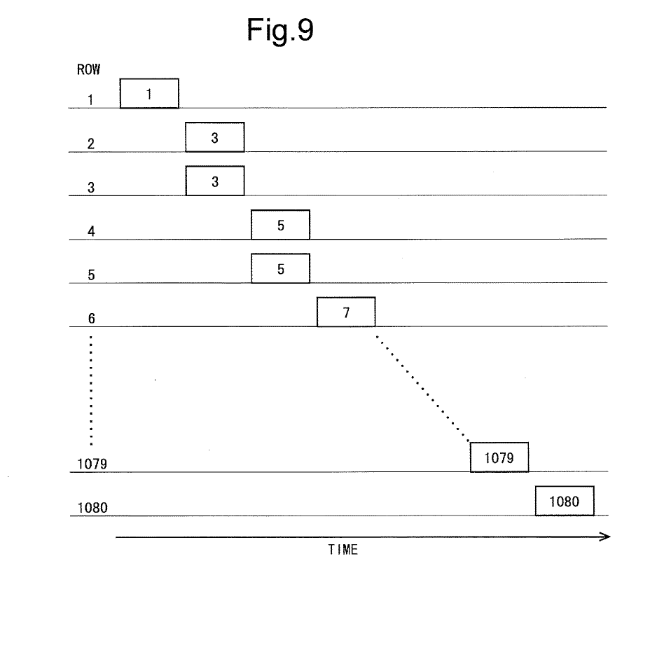

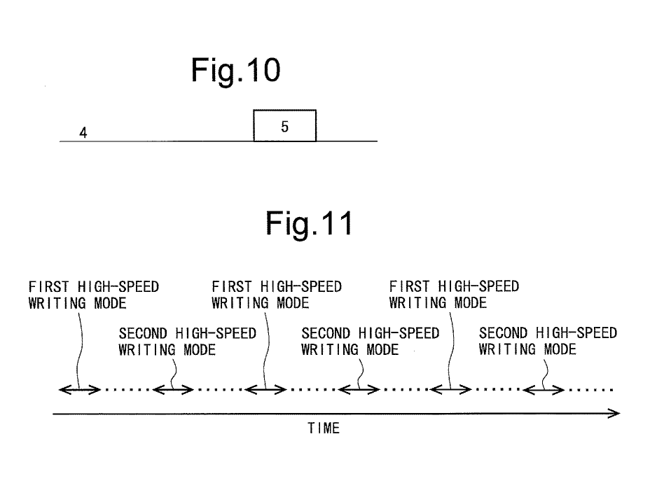

FIG. 7 is a diagram schematically representing the manner of writing data in the normal writing mode. FIG. 8 is a diagram schematically representing the manner of writing data in the first high-speed writing mode. FIG. 9 is a diagram schematically representing the manner of writing data in the second high-speed writing mode. It should be noted that, as to the illustrations of FIGS. 7 to 9, for example, an illustration of FIG. 10 represents that “data originally in a fifth row is written into the pixel portion 4 in the fourth row.”

In the green field F(G) and the red field F(R), the data writing processing in the normal writing mode is performed. At that time, field data as schematically shown in FIG. 6 is used. Thus, as shown in FIG. 7, data is written sequentially one row by one row such that original data is written into every row. As described above, in the green field F(G) and the red field F(R), the data writing processing similar to the conventional technique is performed.

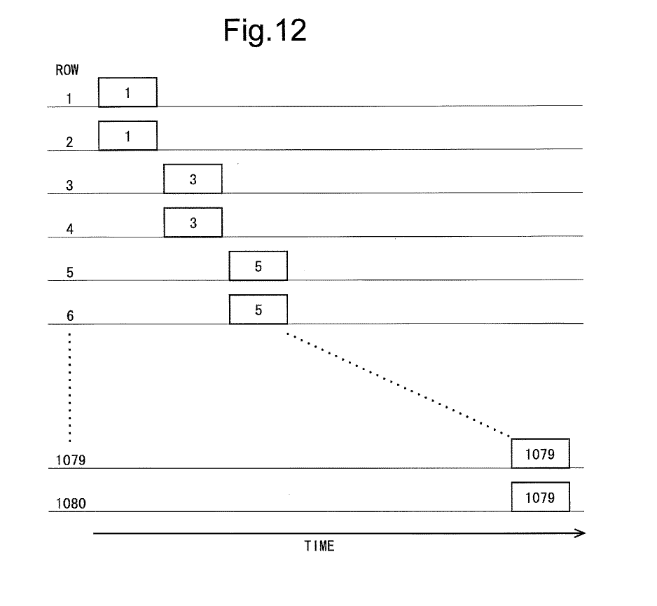

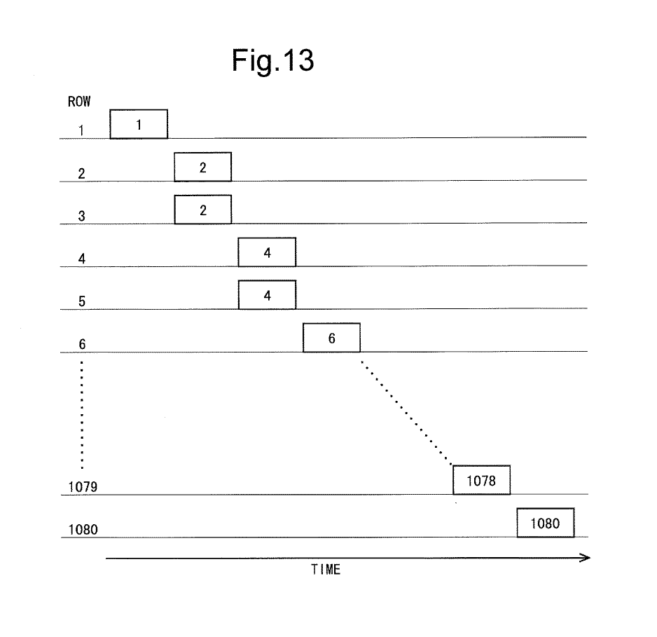

In the blue field F(B), the data writing processing in the high-speed writing mode is performed. More specifically, in the odd-numbered frame, the data writing processing in the first high-speed writing mode is performed using the field data as schematically shown in FIG. 4, and in the even-numbered frame, the data writing processing in the second high-speed writing mode is performed using the field data as schematically shown in FIG. 5. That is, when focusing only on the blue field F(B), the data writing processing in the first high-speed writing mode and the data writing processing in the second high-speed writing mode are alternately performed as shown in FIG. 11. Hence in the odd-numbered frame, data is written sequentially two rows by two rows as shown in FIG. 8, and in the even-numbered frame, data is written sequentially two rows by two rows except for the first row (top row) and the 1080th row (last row) as shown in FIG. 9. More specifically, in the odd-numbered frame, original data for the (p+1)th row is written into the pth row and the (p+1)th row, and in the even-numbered frame, original data for the (q+1)th row is written into the qth row and the (q+1)th row. Here, as described above, p is an odd number not smaller than 1 and not larger than 1079, and q is an even number not smaller than 2 and not larger than 1078. It should be noted that the configuration may be such that original data for the pth row is written into the pth row and the (p+1)th row as shown in FIG. 12 in the odd-numbered frame, and original data for the qth row is written into the qth row and the (q+1)th row as shown in FIG. 13 in the even-numbered frame. As described above, in the present embodiment, the data having the same value is written into two rows at a time in each column in the blue field F(B). In addition, data indicating an average value of data in two rows in a longitudinal direction (a direction in which the source bus line extends) may be created and written into the two rows. That is, the configuration may be sucha that an average value of the original data for the pth row and the original data for the (p+1)th row is obtained and the data indicating the average value is written into the pth row and the (p+1)th row in the odd-numbered frame, and an average value of the original data for the qth row and the original data for the (q+1)th row is obtained and the data indicating the average value is written into the qth row and the (q+1)th row in the even-numbered frame.

As described above, in the present embodiment, data is written into one row at a time in the green field F(G) and the red field F(R), and data is written into two rows at a time in the blue field F(B). Thus, as shown in FIG. 1, the data writing period TW(B) in the blue field F(B) is about one-half as long as the data writing period TW(G) in the green field F(G) and the data writing period TW(R) in the red field F(R).

Meanwhile, in the blue field F(B), data is written into the pixel portions 4 in two rows at a time, and hence original data is not written into every pixel portion 4. Thus, a display image in each frame does not necessarily coincide with an image to be originally displayed. However, normally, pieces of data in two vertically adjacent rows are often data highly relevant to each other (i.e., data having the same value, or data with values close to each other). Further, since the sensitivity (visibility) of the human eyes to blue is typically low, the low resolution of blue data has a small influence on the image quality. According to the above, great deterioration in image quality does not occur due to data being written into the pixel portions 4 in two rows at a time in the blue field F(B). Further, in this regard, in the blue field F(B), the writing in the first high-speed writing mode using the field data of a first pattern (cf. FIG. 4) and the writing in the second high-speed writing mode using the field data of a second pattern (cf. FIG. 5) are alternately performed, and hence the resolution in the longitudinal direction (the direction in which the source bus line extends) simulatively increases. Also from this viewpoint, the deterioration in image quality is suppressed.

### 1.5 Effect

According to the present embodiment, in the blue field F(B) of the three fields constituting one frame, data is written into the pixel portions 4 in two rows at a time. For this reason, the length of the data writing period TW(B) in the blue field F(B) is about one-half as long as before. Hence a relative length of the light-source lighting period TE with respect to the length of one frame can be made larger than before. As thus described, in the liquid crystal display device employing the field-sequential system, the light-source lighting period with a sufficient length can be ensured. Therefore, the number of light sources to be installed in the liquid crystal display device in order to obtain desired display brightness can be made smaller than before. This results in achievement of cost reduction regarding installation of the light source, space saving, weight reduction, and the like.

Further, employing an oxide TFT (a thin-film transistor formed by using an oxide semiconductor for a channel layer) to the TFT 40 provided in each pixel portion 4 in the display portion 400 can lead to a higher writing speed than before, in addition to obtaining the effects of higher resolution and lower power consumption. Hence it is possible to more effectively make the light-source lighting period longer.

### 1.6 Modified Example

Although the description has been given exemplifying the liquid crystal display device as the image display device in the first embodiment, the present invention is not limited thereto. The present invention is also applicable to any image display device as long as it performs gradation display by controlling transmission/shading of light, such as an electro-wetting display device, in addition to the liquid crystal display device. Moreover, the present invention is also applicable to any image display device as long as it performs gradation display by controlling reflection/absorption of light, such as a DMD projector, a display device using electronic ink, and a reflective liquid crystal display device. These also apply to second to sixth embodiments described later.

Further, although the description has been given exemplifying the LED as the light-emission device (light source) 310 in the first embodiment, the present invention is not limited thereto. Any device capable of controlling the lighted/unlighted state of each color individually, such as a fluorescent tube and a laser light source, may be used as the light emission device (light source) 310. This also applies to the second to ninth embodiments described later.

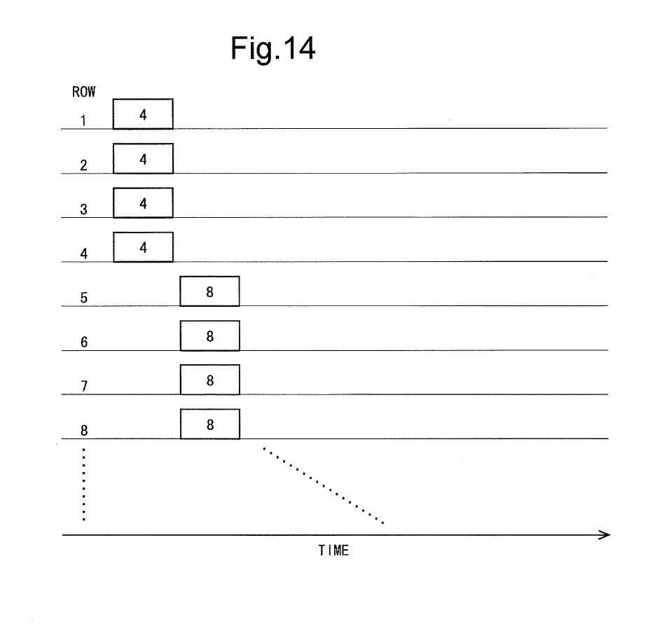

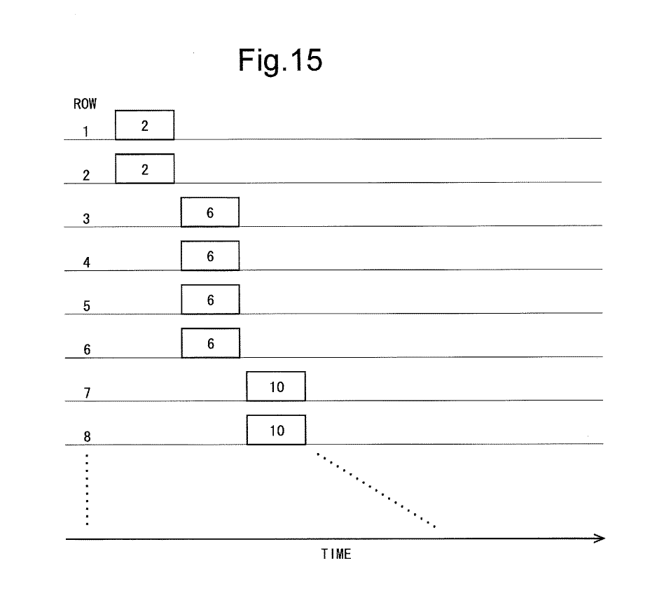

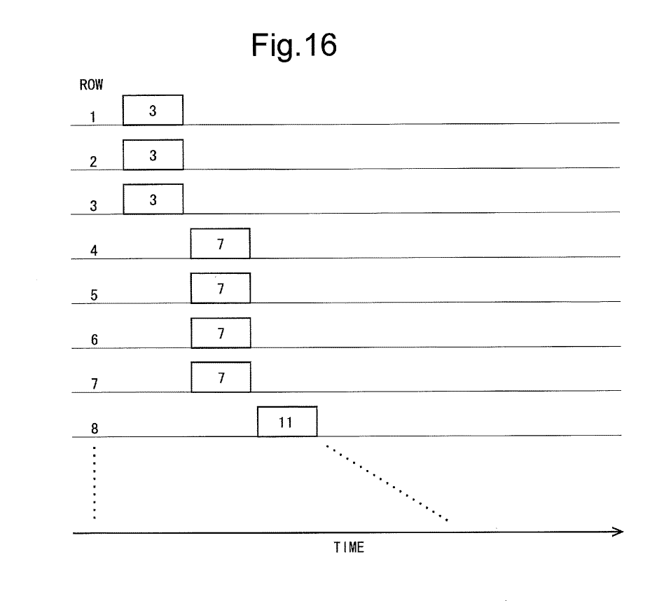

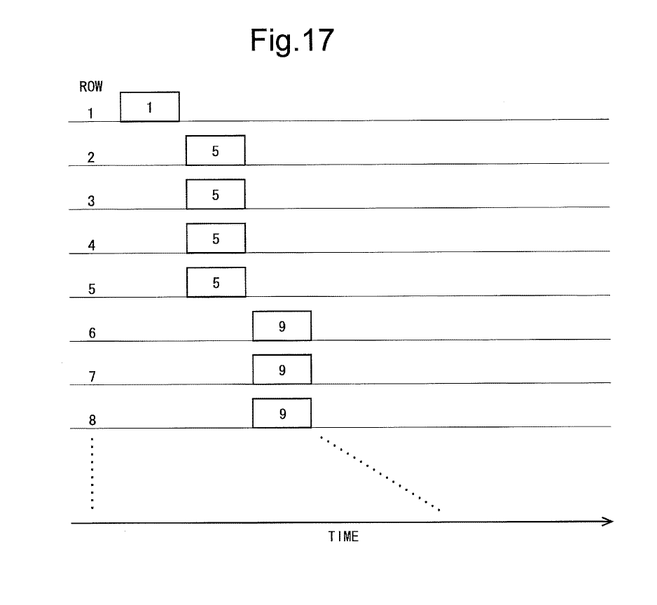

Moreover, data has been written into the pixel portions 4 in two rows at a time during the high-speed writing mode in the first embodiment, but the present invention is not limited thereto. In the high-speed writing mode, data may be written into the pixel portions 4 in four rows at a time, for example. In this case, concerning the data writing processing in the blue field F(B) in each of four consecutive frames, for example, the data writing processing may be performed as shown in FIG. 14 in the first frame, the data writing processing may be performed as shown in FIG. 15 in the second frame, the data writing processing may be performed as shown in FIG. 16 in the third frame, and the data writing processing may be performed as shown in FIG. 17 in the fourth frame. It should be noted that, for example, in the first frame (cf. FIG. 14), data in the row other than the fourth row (any data in the first to third rows) may be written into the first to fourth rows. Further, when focusing on the four rows into which data is simultaneously written, data indicating an average value of data in the four rows in the longitudinal direction may be written into the four rows. As described above, when data is to be written into z rows at a time, Z writing patterns may be prepared and each of the Z patterns may be made to appear each time over Z frames. In addition, the fact that the data-writing unit in the high-speed writing mode is not limited to two rows also applies to the second to ninth embodiments described later.

Furthermore, although the two high-speed writing modes have been used in the first embodiment, the present invention is not limited thereto. Either the first high-speed writing mode or the second high-speed writing mode may be used. In such a configuration, the resolution in the longitudinal direction decreases, but the relative length of the light-source lighting period with respect to the length of one frame can be made larger than before, as in the first embodiment.

### 2. Second Embodiment

### <2.1 Summary>

A second embodiment of the present invention is described. Note that a description is given only of a different point from the first embodiment, and a description of a similar point to the first embodiment is omitted. This also applies to each embodiment described later.

According to the first embodiment, the length of the data writing period TW(B) in the blue field F(B) is about one-half as long as before, and hence the relative length of the light-source lighting period TE with respect to the length of one frame can be made larger than before. However, a still longer light-source lighting period TE may be required. Meanwhile, concerning the sensitivity (visibility) of the human eyes to the three primary colors, the sensitivity to blue is the lowest, and the sensitivity to red is the second lowest. Hence, in the present embodiment, data is written into the pixel portions 4 in two rows at a time in the red field F(R) in addition to the blue field F(B).

### 2.2 Drive Method

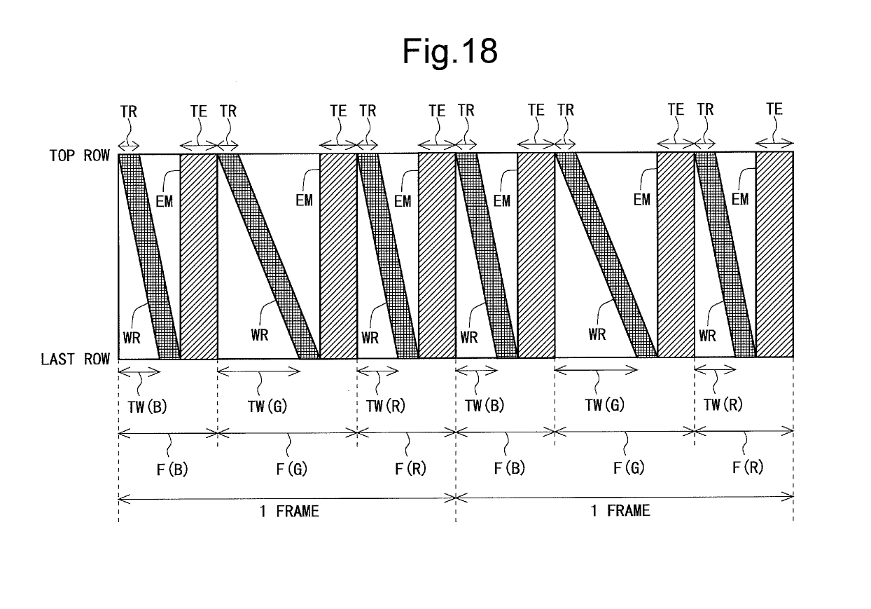

FIG. 18 is a diagram for describing a drive method in the present embodiment. Similarly to the first embodiment, one frame includes three fields consisting of the blue field F(B), the green field F(G), and the red field F(R). As described above, in the present embodiment, data is written into the pixel portions 4 two rows by two rows in the blue field F(B) and the red field F(R). Concerning the processing of writing data into the pixel portions 4 in the blue field F(B) and the red field F(R), for example, the data writing processing in the first high-speed writing mode is performed as shown in FIG. 8 in the odd-numbered frame, and the data writing processing in the second high-speed writing mode is performed as shown in FIG. 9 in the even-numbered frame. Concerning the processing of writing data into the pixel portions 4 in the green field F(G), the data writing processing in the normal writing mode is performed as shown in FIG. 7 in all the frames.

As described above, in the present embodiment, data is written into one row at a time in the green field F(G), and data is written into two rows at a time in the blue field F(B) and the red field F(R). Thus, as shown in FIG. 18, the data writing period TW(B) in the blue field F(B) and the data writing period TW(R) in the red field F(R) are about one-half as long as the data writing period TW(G) in the green field F(G).

### 2.3 Effect

According to the present embodiment, the relative length of the light-source lighting period TE with respect to the length of one frame can be made still larger than that in the first embodiment. Therefore, the number of light sources to be installed in the liquid crystal display device in order to obtain desired display brightness can be made still smaller. This results in achievement of further cost reduction regarding installation of the light source, further space saving, and further weight reduction.

### 3. Third Embodiment

### 3.1 Summary

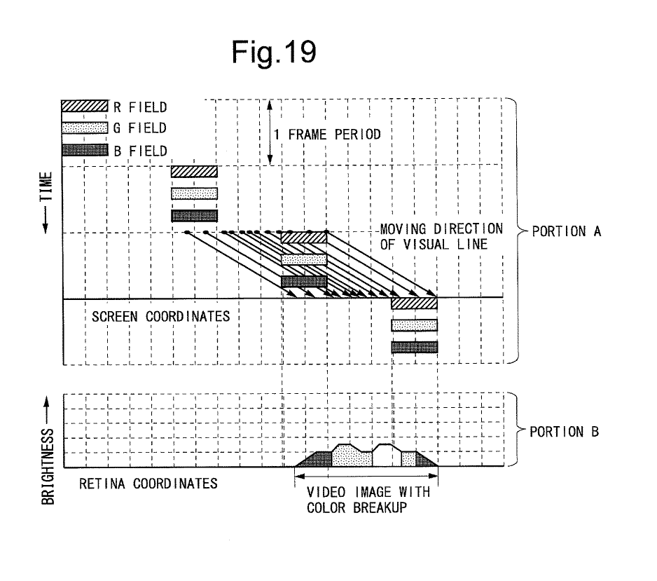

The field-sequential liquid crystal display device has a problem of occurrence of color breakup. FIG. 19 is a diagram showing a principle of occurrence of the color breakup. In a portion A of FIG. 19, a vertical axis represents time, and a horizontal axis represents a position on a screen. Generally, when an object moves in a display screen, an observer's visual line follows the object and moves in a moving direction of the object. For example, in the example shown in FIG. 19, when a white object moves from left to right in the display screen, the observer's visual line moves in a direction of oblique arrows. Meanwhile, when three field images of R, G, and B are extracted from a video image at the same moment, a position of the object in each field is the same. For this reason, the color breakup occurs in a video image reflected in a retina as shown in a portion B of FIG. 19. In the present embodiment, in order to suppress the occurrence of the color breakup as described above, a field for displaying a component of a mixed color (a color obtained by mixing the primary colors) is provided within one frame.

### 3.2 Drive Method

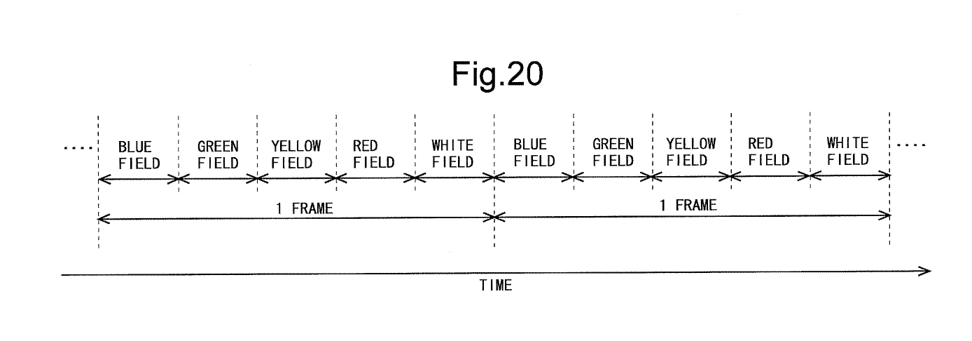

FIG. 20 is a diagram showing a configuration of frames in the present embodiment. Note that FIG. 20 shows a configuration of two frames. As shown in FIG. 20, one frame includes five fields consisting of a blue field, a green field, a yellow field, a red field, and a white field. That is, the yellow field and the white field are provided in addition to the fields in the first embodiment and the second embodiment. In the yellow field, yellow display is performed by the red LED and the green LED coming into the lighted state. In the white field, white display is performed by the red LED, the green LED, and the blue LED coming into the lighted state. Note that the order of the five fields is not limited to the order shown in FIG. 20. However, from the viewpoint of suppressing the occurrence of the color breakup, the green field and the red field are preferably made adjacent to the yellow field.

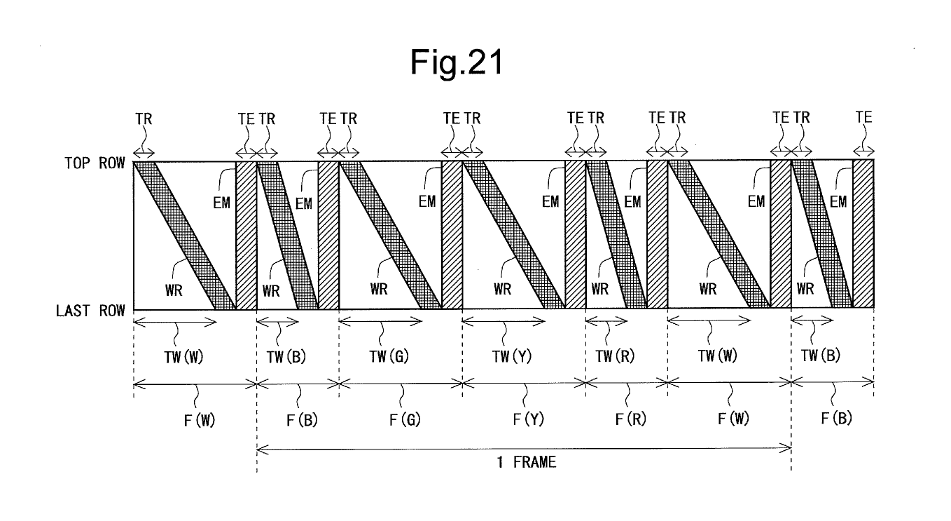

FIG. 21 is a diagram for describing a drive method in the present embodiment. As described above, one frame includes the five fields consisting of the blue field F(B), the green field F(G), the yellow field F(Y), the red field F(R), and the white field F(W). In the present embodiment, data is written into the pixel portions 4 one row by one row in the green field F(G), the yellow field F(Y), and the white field F(W), and data is written into the pixel portions 4 two rows by two rows in the blue field F(B) and the red field F(R). Concerning the processing of writing data into the pixel portions 4 in the blue field F(B) and the red field F(R), for example, the data writing processing in the first high-speed writing mode is performed as shown in FIG. 8 in the odd-numbered frame, and the data writing processing in the second high-speed writing mode is performed as shown in FIG. 9 in the even-numbered frame. Concerning the processing of writing data into the pixel portions 4 in the green field F(G), the yellow field F(Y), and the white field F(W), the data writing processing in the normal writing mode is performed as shown in FIG. 7 in all the frames. Note that, since the sensitivity (visibility) of the human eyes to white and yellow is relatively high, the normal writing mode is employed in the white field F(W) and the yellow field F(Y).

As described above, in the present embodiment, data is written into one row at a time in the green field F(G), the yellow field F(Y), and the white field F(W), and data is written into two rows at a time in the blue field F(B) and the red field F(R). Thus, as shown in FIG. 21, the data writing periods TW(B), TW(R) in the blue field F(B) and the red field F(R) are about one-half as long as the data writing periods TW(G), TW(Y), TW(W) in the green field F(G), the yellow field F(Y), and the white field F(W).

### 3.3 Effect

According to the present embodiment, each frame includes the field for displaying the mixed color component. Hence the occurrence of the color breakup is suppressed. Further, in the blue field F(B) and the red field F(R) of the five fields constituting one frame, data is written into two rows at a time. It is thereby possible to suppress the occurrence of the color breakup, while ensuring the light-source lighting period with a sufficient length. According to the above, concerning the liquid crystal display device that exerts the effect of reducing the color breakup, it is possible to achieve the cost reduction regarding installation of the light source, space saving, and weight reduction.

### 3.4 Modified Example

In the third embodiment, the two fields, i.e., the yellow field and the white field are provided in addition to the general three fields. However, from the viewpoint of the data writing period, the charging time, the response speed of liquid crystal, and the like, adding the two fields while suppressing the occurrence of a flicker may be difficult. Therefore, in the present modified example, only the white field is provided as the field for displaying the mixed color component.

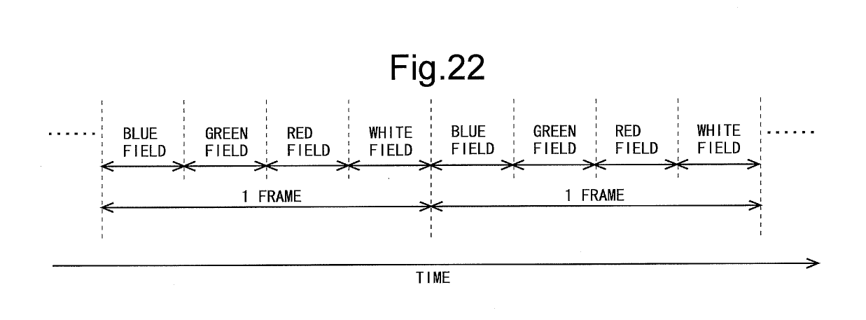

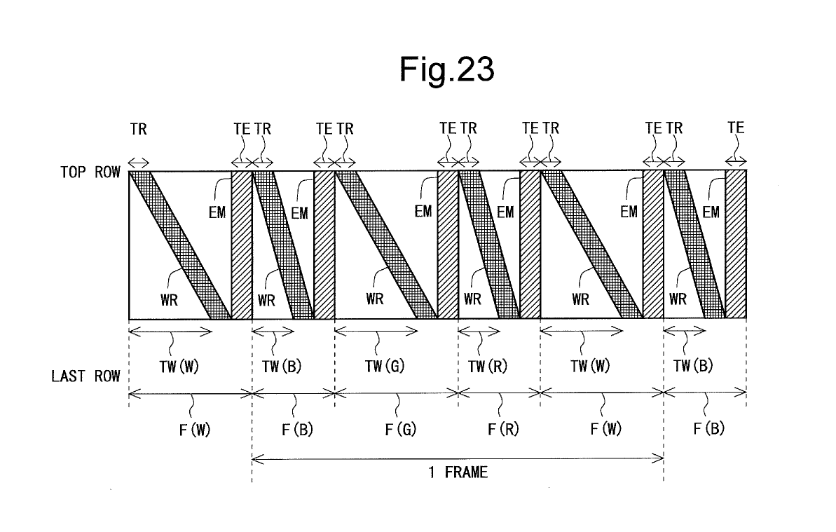

FIG. 22 is a diagram showing a configuration of frames in the present modified example. As shown in FIG. 22, one frame includes four fields consisting of the blue field, the green field, the red field, and the white field. FIG. 23 is a diagram for describing a drive method in the present modified example. In the present modified example, data is written into the pixel portions 4 in one row at a time in the green field F(G) and the white field F(W), and data is written into the pixel portions 4 in two rows at a time in the blue field F(B) and the red field F(R).

According to the present modified example, it is possible to achieve cost reduction regarding installation of the light source, space saving, and weight reduction, while exerting the effect of reducing the color breakup to a certain extent.

### 4. Fourth Embodiment

### 4.1 Summary

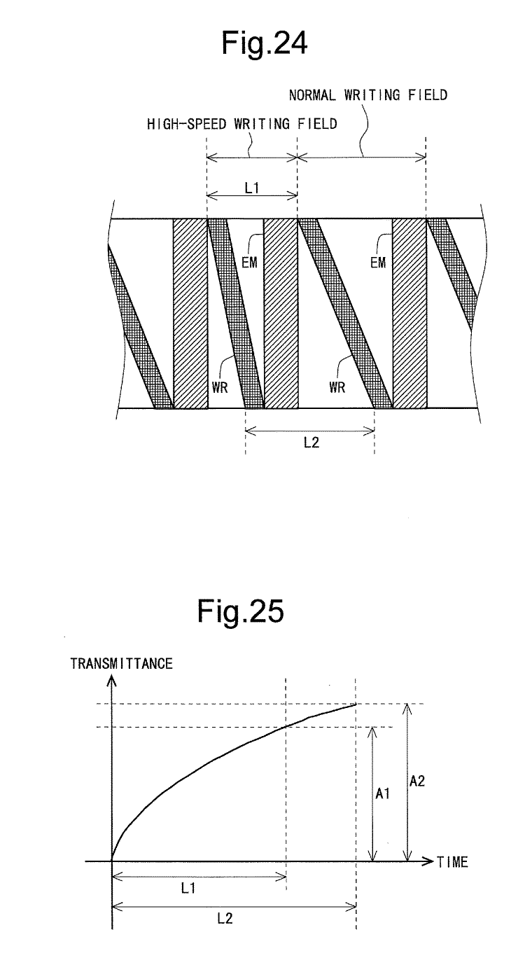

In each of the first to third embodiments, there are the field in which the data writing processing in the normal writing mode is performed (hereinafter referred to as “normal writing field”) and the field in which the data writing processing in the high-speed writing mode is performed (hereinafter referred to as “high-speed writing field”). The length of the data writing period is different between the normal writing field and the high-speed writing field. For this reason, when the normal writing field and the high-speed writing field are consecutive, the length from the time point of writing data in the preceding field to the time point of writing data in the subsequent field is different between the top row and the last row. For example, as shown in FIG. 24, when the normal writing field is provided subsequent to the high-speed writing field, as to the length from the time point of writing data in the high-speed writing field to the time point of writing data in the normal writing field, a length L1 in the top row is shorter than a length L2 in the last row.

Meanwhile, an optical response time of liquid crystal molecules used for the liquid crystal display device varies, and a typical response time is from a several milliseconds to a several tens of milliseconds. For this reason, liquid crystal may not completely respond so as to obtain a desired transmittance within each field. In such a case, when the length from the time point of writing data in the preceding field to the time point of writing data in the subsequent field is different between the top row and the last row as described above, a difference occurs in attained level with respect to a target transmittance between the top row and the last row. In the example shown in FIG. 24, even when the transmittance should change in the same manner in the top row and the last row, an attained level A1 in the top row is lower than an attained level A2 in the last row, as shown in FIG. 25. According to the above, even when uniform color display is to be performed in the whole screen, different colors are displayed at the upper end of the screen and the lower end thereof. When the attained level with respect to the target transmittance is different depending on the row as described above, performing uniform color display in the screen is difficult. Hence in the present embodiment, writing data in the high-speed writing mode is performed in all the fields such that the cycle for writing data is the same in all the rows.

### 4.2 Drive Method

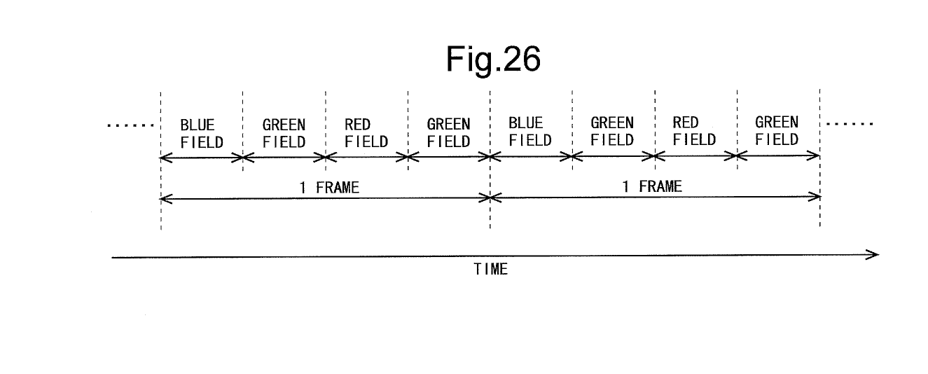

FIG. 26 is a diagram showing a configuration of frames in the present embodiment. Note that FIG. 26 shows a configuration of two frames. In the present embodiment, one frame includes the blue field, the green field, and the red field. However, as shown in FIG. 26, the frames are configured such that the green field appears twice within one frame. The reason for this configuration is that, since the sensitivity (visibility) of the human eyes to green is high, the deterioration in image quality due to the low resolution in each green field is suppressed. Further, in the green field that appears twice in each frame, writing in the first high-speed writing mode using the field data in the first pattern (cf. FIG. 4) and writing in the second high-speed writing mode using the field data in the second pattern (cf. FIG. 5) are alternately performed, to simulatively increase the resolution in the longitudinal direction.

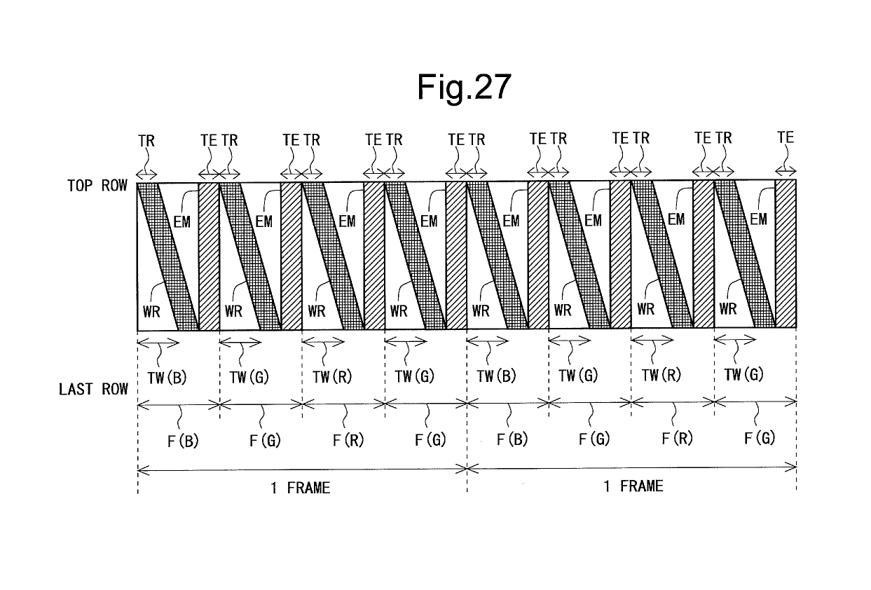

FIG. 27 is a diagram for describing a drive method in the present embodiment. In the present embodiment, data is written into the pixel portions 4 two rows by two rows in all the fields. Concerning the processing of writing data into the pixel portions 4 in the blue field F(B) and the red field F(R), for example, the data writing processing in the first high-speed writing mode is performed as shown in FIG. 8 in the odd-numbered frame, and the data writing processing in the second high-speed writing mode is performed as shown in FIG. 9 in the even-numbered frame. As thus described, as to the blue field F(B) and the red field F(R), the data writing processing in two patterns are performed across the frames as in the first to third embodiments. Concerning the processing of writing data into the pixel portions 4 in the green field F(G), for example, the data writing processing in the first high-speed writing mode is performed as shown in FIG. 8 in the first green field F(G) of each frame, and the data writing processing in the second high-speed writing mode is performed as shown in FIG. 9 in the second green field F(G) of each frame. In such a manner as above, in the present embodiment, the length of the data writing period is the same in all the fields.

### 4.3 Effect

According to the present embodiment, data is written into the pixel portions 4 in two rows at a time in all the fields. For this reason, the cycle for writing data into the pixel portions 4 is constant irrespective of the position (the position of the row into which data is written) in the screen. Hence, even when the liquid crystal does not completely respond such that a desired transmittance is obtained within each field, no difference occurs in attained level with respect to a target transmittance between the upper end of the screen and the lower end thereof. Thus, uniform color display can be performed in the screen irrespective of the response speed of the liquid crystal. Further, since data is written into two row at a time in each field, the light-source lighting period with a sufficient length is ensured. According to the above, it is possible to achieve cost reduction regarding installation of the light source, space saving, and weight reduction, while enabling uniform color display on the whole screen.

### 5. Fifth Embodiment

### 5.1 Summary

In the fourth embodiment, one frame has included the blue field, the green field, and the red field. However, as described above, the color breakup may occur in the field-sequential liquid crystal display device. Therefore, in the present embodiment, the white field and the yellow field are added to the configuration of the frame in the fourth embodiment.

### 5.2 Drive Method

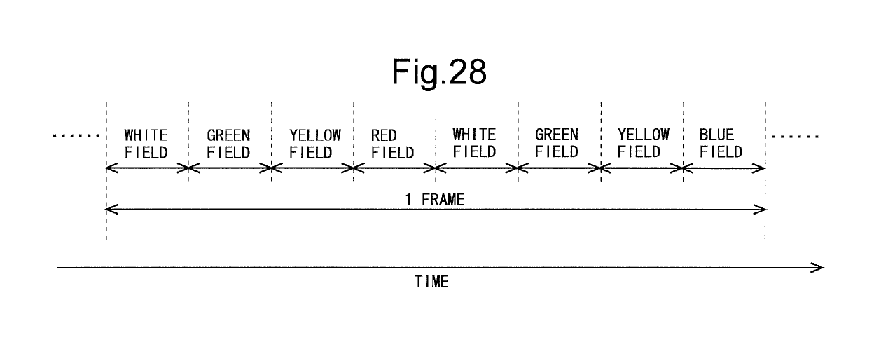

FIG. 28 is a diagram showing a configuration of a frame in the present embodiment. In the present embodiment, one frame includes the white field, the green field, the yellow field, the red field, and the blue field. Note that the sensitivity of the human eyes to white and yellow is relatively high. Therefore, as shown in FIG. 28, the frame is configured such that the white field and the yellow field also appear twice in addition to the green field.

Note that, from the viewpoint of the data writing period, the charging time, the response speed of liquid crystal, and the like, adding the two fields while suppressing the occurrence of a flicker may be difficult. In such a case, as in the modified example of the third embodiment, only the white field may be provided as the field for displaying the mixed color component.

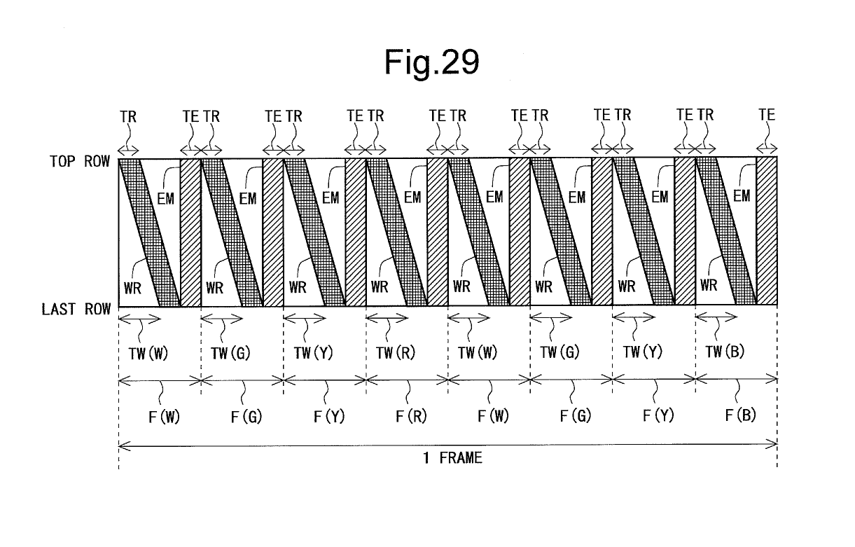

FIG. 29 is a diagram for describing a drive method in the present embodiment. Similarly to the fourth embodiment, data is written into the pixel portions 4 two rows by two rows in all the fields. Concerning the processing of writing data into the pixel portions 4 in the blue field F(B) and the red field F(R), for example, the data writing processing in the first high-speed writing mode is performed as shown in FIG. 8 in the odd-numbered frame, and the data writing processing in the second high-speed writing mode is performed as shown in FIG. 9 in the even-numbered frame. Concerning the processing of writing data into the pixel portions 4 in the white field F(W), the green field F(G), and the yellow field F(Y), for example, the data writing processing in the first high-speed writing mode is performed as shown in FIG. 8 in the respective first fields of each frame, and the data writing processing in the second high-speed writing mode is performed as shown in FIG. 9 in the respective second fields of each frame. In such a manner as above, in the present embodiment, the length of the data writing period is the same in all the fields.

### 5.3 Effect

According to the present embodiment, data is written into the pixel portions 4 in two rows at a time in all the fields. Thus, similarly to the fourth embodiment, uniform color display can be performed in the screen irrespective of the response speed of the liquid crystal. Further, each frame includes the field for displaying the mixed color component. Hence the occurrence of the color breakup is suppressed. According to the above, concerning the liquid crystal display device that exerts the effect of reducing the color breakup, it is possible to achieve cost reduction regarding installation of the light source, space saving, and weight reduction, while enabling uniform color display on the whole screen.

### 6. Sixth Embodiment

### 6.1 Summary

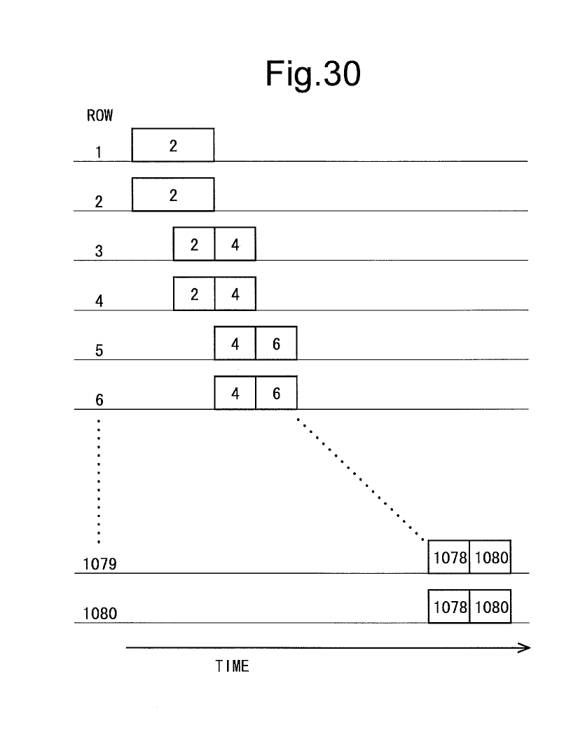

In the first to fifth embodiments, in the high-speed writing mode, data has been written as shown in FIG. 8, for example. In contrast, in the present embodiment, data is written as shown in FIG. 30, for example. That is, when a set of rows, into which data is written at the same timing when the data writing processing in the high-speed writing mode is performed, is defined as a “group”, some period on the start-time-point side of a period for writing of data into an nth group overlaps with some period on the end-time-point side of a period for writing of data into an (n−1)th group, and some period on the end-time-point side of the period for writing of data into the nth group overlaps with some period on the start-time-point side of a period for writing of data into an (n+1)th group. For example, the first half of a period for writing of data into a second group (the third and fourth rows) overlaps with the latter half of a period for writing of data into a first group (the first and second rows), and the latter half of the period for writing of data into the second group overlaps with the first half of a period for writing of data into a third group (the fifth and sixth rows). The present embodiment seeks to further reduce the data writing period as a whole by providing the data writing periods that overlap between the adjacent groups as described above. It should be noted that, in the present embodiment, the data writing periods that overlap between two adjacent rows are also provided in the normal writing mode.

### 6.2 Drive Method

Similarly to the first embodiment, one frame includes three fields consisting of the blue field, the green field, and the red field (cf. FIG. 3). Further, similarly to the first embodiment, the data writing processing in the high-speed writing mode is performed in the blue field, and the data writing processing in the normal writing mode is performed in the green field and the red field.

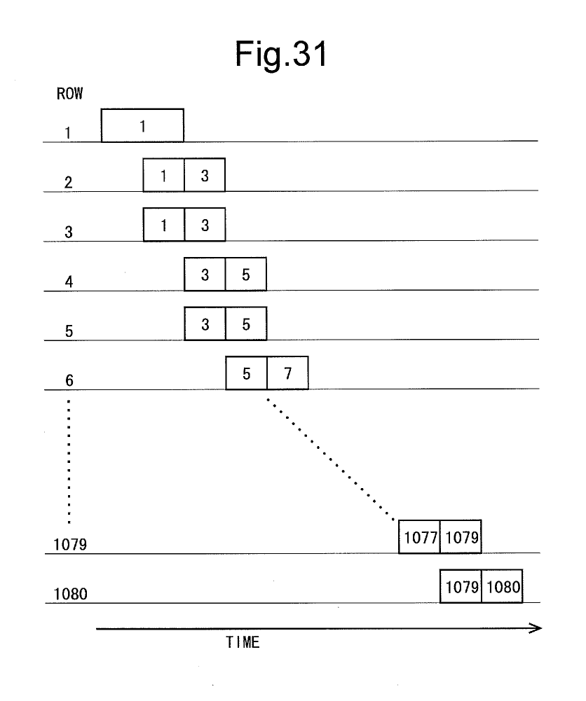

As described above, the data writing processing in the high-speed writing mode is performed in the blue field. More specifically, in the odd-numbered frame, the data writing processing in the first high-speed writing mode is performed as shown in FIG. 30, and in the even-numbered frame, the data writing processing in the second high-speed writing mode is performed as shown in FIG. 31. Here, attention is focused on the period for writing of data into any nth group. Then, it can be seen from FIGS. 30 and 31 that data is written using data in the last row of the (n−1)th group in the first half of the focused period. Further, it can be seen from FIGS. 30 and 31 that data is written using data in the last row of the nth group in the latter half of the focused period.

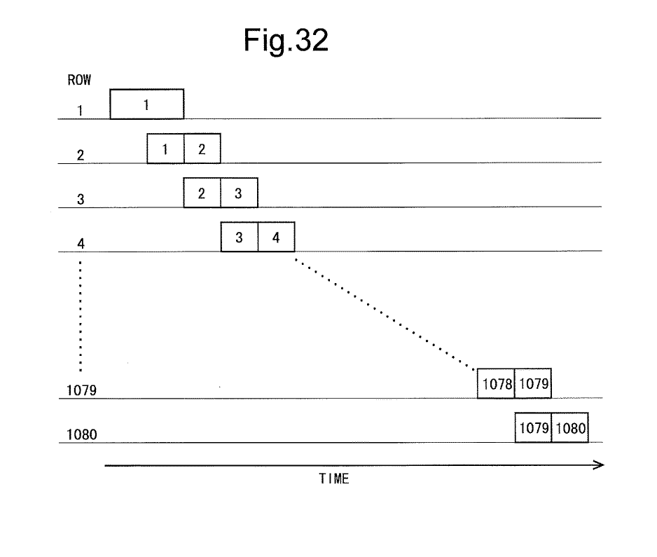

As described above, the data writing processing in the normal writing mode is performed in the green field and the red field. At that time, data is written as shown in FIG. 32. That is, the first half of a period for writing of data into each row overlaps with the latter half of a period for writing of data into a preceding row, and the latter half of the period for writing of data into each row overlaps with the first half of a period for writing of data into a subsequent row. Moreover, it can be seen from FIG. 32 that, in the first half of the period for writing of data into each row, data is written using data in the preceding row, and in the latter half of the period for writing of data into each row, data is written using data in relevant row.

It should be noted that, concerning the period for writing of data into each group or each row, each of FIGS. 30 to 32 illustrates as if the first 50% of the period overlaps with the period for writing of data into the preceding group or row and the latter 50% of the period overlaps with the period for writing of data into the subsequent group or row, but the present invention is not limited thereto. For example, it may be configured such that the first 25% of the period overlaps with the period for writing of data into the preceding group or row and the last 25% of the period overlaps with the period for writing of data into the subsequent group or row.

### 6.3 Effect

According to the present embodiment, the data writing periods that overlap between the adjacent groups or rows are provided. During writing of data into each group or each row, in the first-half period, data is written based on data in the preceding group or the preceding row. Normally, data in adjacent groups or rows are often data highly relevant to each other, and hence the first-half period of the data writing period is useful as a preliminary charging period. According to the above, it is possible to make the data writing period as a whole significantly shorter than before without causing the deterioration in image quality. Therefore, the number of light sources to be installed in the liquid crystal display device in order to obtain desired display brightness can be more reliably made smaller than before. This results in achievement of cost reduction regarding installation of the light source, space saving, weight reduction, and the like, in a more effective manner.

### 6.4 Modified Example

The sixth embodiment has employed the drive method in which the data writing periods that overlap between the adjacent groups or rows as described above are provided on the basis of the first embodiment, but a similar drive method may be employed on the basis of the second to fifth embodiments.

### 7. Seventh Embodiment

### 7.1 Configuration

Although the description has been given taking the liquid crystal display device as the example in the first embodiment, the present invention is also applicable to an image display device that performs binary control, such as a ferroelectric liquid crystal display device, or a DMD projector. Hereinafter, embodiments (seventh to ninth embodiments) to be applied to the image display device that performs the binary control are described taking the DMD projector as an example.

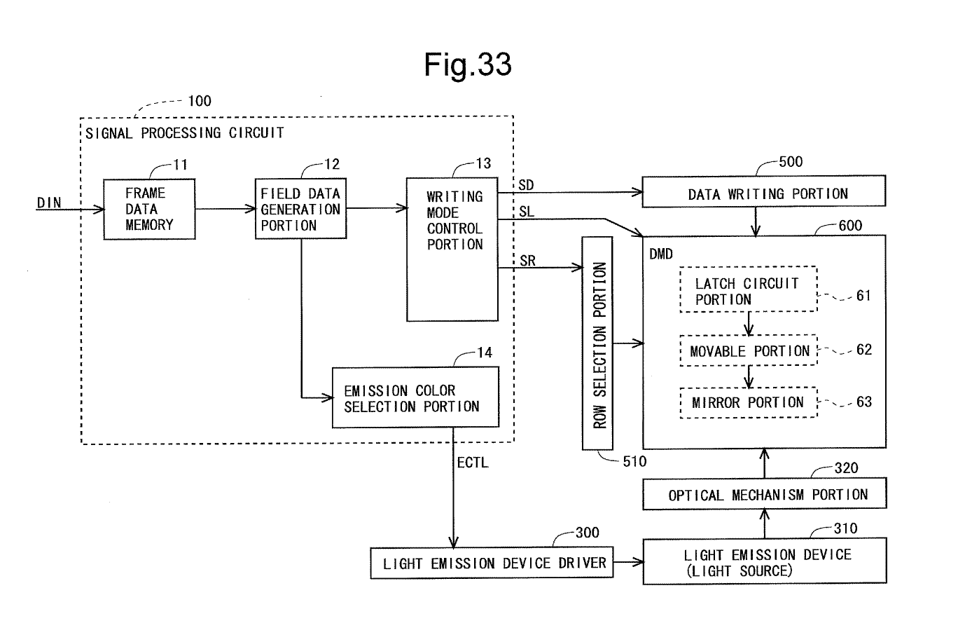

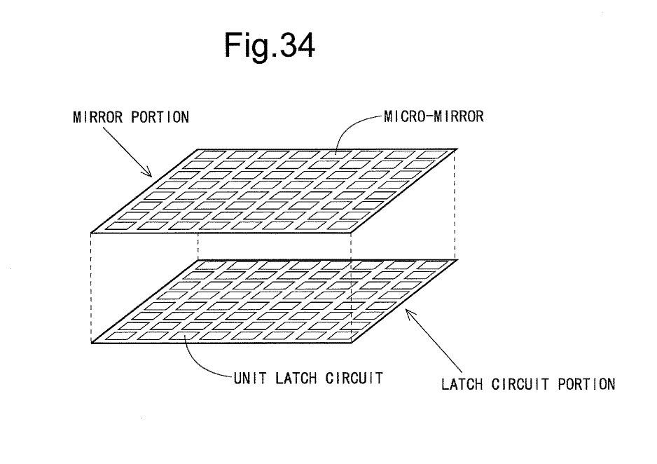

FIG. 33 is a block diagram showing an overall configuration of the DMD projector according to a seventh embodiment of the present invention. This DMD projector is configured by a signal processing circuit 100, a data writing portion 500, a row selection portion 510, a light emission device driver 300, a light emission device (light source) 310, an optical mechanism portion 320, and a DMD (digital micro-mirror device) 600. The signal processing circuit 100 includes a frame data memory 11, a field data generation portion 12, a writing mode control portion 13, and an emission color selection portion 14. It should be noted that, also in the present embodiment, it is assumed that LEDs of three colors (a red LED, a green LED, and a blue LED) are employed as the light emission device (light source) 310.

The DMD 600 is configured by a latch circuit portion 61, a movable portion 62, and a mirror portion 63. The mirror portion 63 is configured by a plurality of micro-mirrors arranged in a matrix form as shown in FIG. 34. The micro-mirror is brought into an on-state or an off-state based on its angle. The latch circuit portion 61 is provided with unit latch circuits such that the unit latch circuits correspond one-to-one to the micro-mirrors in the mirror portion 63. That is, in the latch circuit portion 61, the unit latch circuits are arranged in a matrix form. The unit latch circuit is configured so as to hold one-bit data. The movable portion 62 (illustration is omitted in FIG. 34) controls the angle of the micro-mirror in accordance with a value of data stored in the unit latch circuit. As described above, in the present embodiment, one pixel portion is configured by one micro-mirror and one unit latch circuit corresponding thereto. When the micro-mirror is in the on-state, a separately provided projection lens (not shown in FIG. 33) is irradiated with reflected light from the micro-mirror. When the micro-mirror is in the off-state, the projection lens is not irradiated with the reflected light from the micro-mirror. In such a manner, for example, a screen is irradiated with the reflected light from the micro-mirror via the projection lens in accordance with the on/off state of all the micro-mirrors in the mirror portion 63, whereby an image is displayed.

Input image data DIN for one frame is stored into the frame data memory 11. The field data generation portion 12 reads frame data from the frame data memory 11, and generates field data based on the frame data. The writing mode control portion 13 provides the field data generated in the field data generation portion 12 to the data writing portion 500 as a data signal SD. Note that this data signal SD is one-bit data. Further, the writing mode control portion 13 controls the writing mode during writing of data into the latch circuit portion 61 in accordance with the field data generated in the field data generation portion 12. In accordance with the writing mode, the writing mode control portion 13 provides a row selection control signal SR to the row selection portion 510. The emission color selection portion 14 selects the color of the LED to be brought into the lighted state in accordance with the field data generated in the field data generation portion 12. The emission color selection portion 14 then provides a light emission control signal ECTL to the light emission device driver 300 in accordance with the selected color.

The data writing portion 500 receives the data signal SD provided from the writing mode control portion 13 and outputs the data signal SD to the latch circuit portion 61 in the DMD 600. The row selection portion 510 selects the unit latch circuit as a destination for writing data based on the row selection control signal SR provided from the writing mode control portion 13. Meanwhile, similarly to the first embodiment, the normal writing mode and the high-speed writing mode are prepared in the present embodiment. In the present embodiment, in the normal writing mode, the unit latch circuits are selected one row by one row by the row selection portion 510, and in the high-speed writing mode, unit latch circuits are selected two rows by two rows by the row selection portion 510. That is, data is written into the pixel portions in one row at a time in the normal writing mode, and data is written into the pixel portions in two rows at a time in the high-speed writing mode.

The light emission device driver 300 controls the state (lighted/unlighted state) of each LED in accordance with the light emission control signal ECTL provided from the emission color selection portion 14. The states of the LEDs of the three colors as the light emission device 310 are thereby controlled. The mirror portion 63 (micro-mirror) of the DMD 600 is irradiated with light emitted from the light emission device 310 via the optical mechanism portion 320. The optical mechanism portion 320 serves to ensure the uniformity of distribution of light that is applied to the mirror portion 63 of the DMD 600. The present embodiment employs, for example, a light integrator that has a hollow structure and obtains a uniform light distribution due to an inner wall shape and surface characteristics of the structure, as the optical mechanism portion 320.

By each constituent operating as described above, the state of the reflected light from the DMD 600 is switched in each field, and a color image based on the input image data DIN is displayed on the screen, or the like.

### 7.2 Drive Method

The DMD projector according to the present embodiment is an image display device that performs the binary control. For this reason, a technique of displaying an image for one frame is different from those in the first to sixth embodiments. Therefore, before the drive method in the present embodiment is descried, a conventional drive method in the image display device that performs binary control (here, a DMD projector is taken as an example) is described.

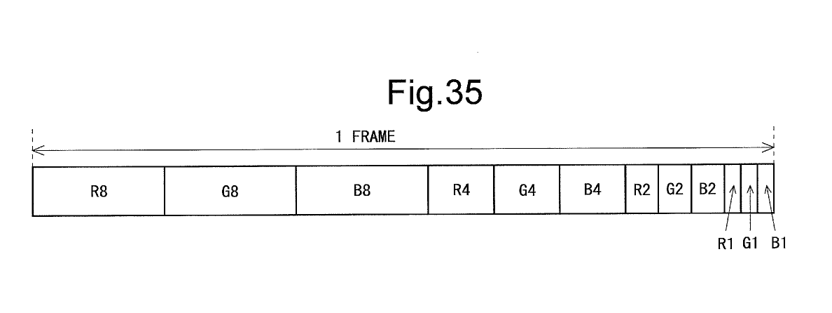

FIG. 35 is a diagram showing one configuration example of one frame. In FIG. 35, symbol starting with “R” denotes a red field, symbol starting with “G” denotes a green field, and symbol starting with “B” denotes a blue field. Further, a numeral value following the alphabet of each field denotes a relative length of the light-source lighting period in each field. As can be seen from FIG. 35, one frame includes four red fields, four green fields, and four blue fields. Four red fields constitute a red field group, four green fields constitute a green field group, and four blue fields constitute a blue field group. In FIG. 35, attention is focused on the red field group. A field R1 is a field with the shortest light-source lighting period among the red fields. The length of the period of a field R2 is twice as large as that of the field R1. The length of the period of a field R4 is twice as large as that of the field R2. The length of the period of a field R8 is twice as large as that of the field R4. As thus described, a ratio of the lengths of the periods of the field R1, the field R2, the field R4, and the field R8 is 1:2:4:8.

As described above, the fields R1, R2, R4, R8 can be associated with four bits. Further, the micro-mirror in the DMD 600 is irradiated with light emitted from the LED as the light emission device 310, and the state of the reflected light from the micro-mirror changes in accordance with the on/off state of the micro-mirror (the configuration of the DMD is the same in the prior art and the present embodiment). Hence, controlling the on/off state of the micro-mirror in each field enables gradation expression of 16 gradations from 0 to 15 for each color. Concerning any pixel portion, for example, when the micro-mirror is brought into the off-state in all the fields R1 to R4, a gradation value of red is 0. Further, for example, when the micro-mirror is brought into the on-state in the fields R1, R4 and the micro-mirror is brought into the off-state in the fields R2, R3, a gradation value of red is 10. In a similar manner, green and blue can also be subjected to the gradation expression of 16 gradations from 0 to 15.

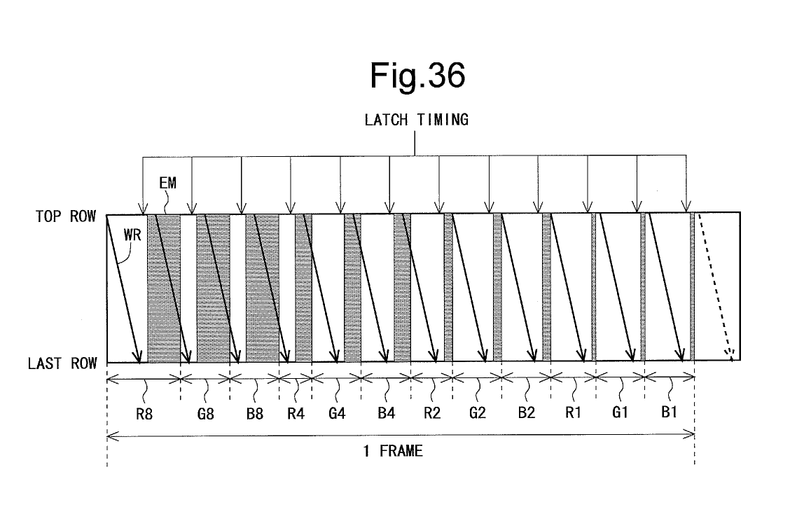

FIG. 36 is a diagram for describing the drive method in the conventional DMD projector. Here, a flow of the processing for performing display for one field is described. As described above, in the DMD 600, the micro-mirrors are arranged in the matrix form in the mirror portion 63, and the unit latch circuits are arranged in the matrix form in the latch circuit portion 61 so as to correspond to the micro-mirrors. In such a configuration, data is written into unit latch circuits one row by one row. Note that data to be written into the unit latch circuit is one-bit data. After data has been written into all rows from the top row to the last row, at the latch timing shown in FIG. 36, the movable portion 62 controls the angle of each micro-mirror in accordance with a value of data held in the unit latch circuit. That is, at the latch timing shown in FIG. 36, the value of data written in the unit latch circuit is reflected to the on/off state of each micro-mirror. Thereafter, the LED is brought into the lighted state. Such an operation is repeatedly performed.

Now, since it is at the above latch timing that the value of data written in the unit latch circuit is reflected to the on/off state of each micro-mirror, even when data for the next field is written during the light-source lighting period of a certain field, no problem occurs in the display. Thus, as shown in FIG. 36, data is written into the unit latch circuit even during the light-source lighting period. As described above, in the present embodiment, there is a period overlapping between the light-source lighting period and the data writing period. In the present description, therefore, a period from the end time point of each light-source lighting period to the end time point of the next light-source lighting period is taken as one field.

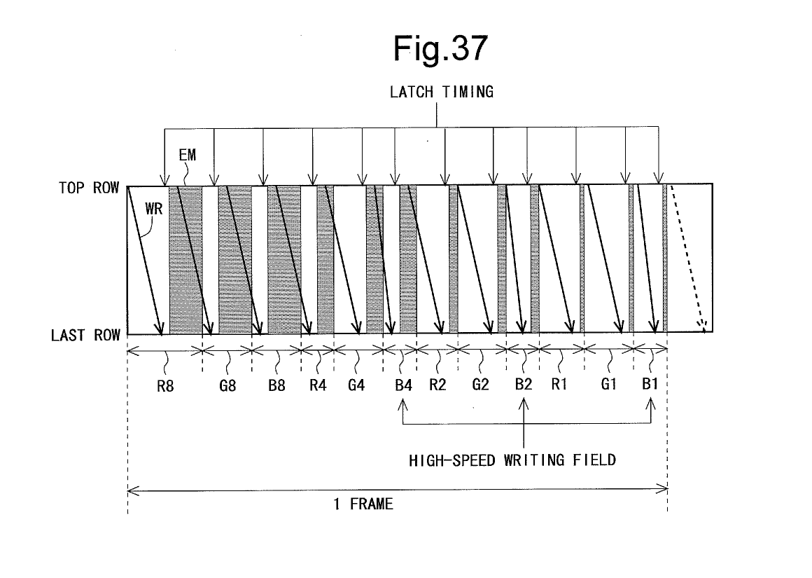

On the premise as described above, the drive method in the present embodiment is described. The configuration of one frame is as shown in FIG. 35, similarly to the conventional technique. FIG. 37 is a diagram for describing the drive method in the present embodiment. In the present embodiment, the data writing processing for display in three fields (a field B4, a field B2, and a field B1) of the blue field group is performed in the high-speed writing mode. More specifically, concerning the data writing processing for display in the field B4, the field B2, and the field B1, for example, the data writing processing in the first high-speed writing mode is performed as shown in FIG. 8 in the odd-numbered frame, and the data writing processing in the second high-speed writing mode is performed as shown in FIG. 9 in the even-numbered frame. Concerning the data writing processing for display in the other fields, the data writing processing in the normal writing mode is performed as shown in FIG. 7 in all the frames.

The reason for employing the high-speed writing mode to the data writing processing for display in the blue field is that, as described above, the sensitivity (visibility) of the human eyes to blue is typically low, and this prevents great deterioration in image quality due to data being written into two rows at a time in the blue field. Note that the data writing processing for display in the field B8 of the blue field group is performed in the normal writing mode. This is because, since the light-source lighting period in the field G8 that is one field before the field B8 is long, even if the data writing processing for display in the field B8 is performed in the high-speed writing mode, the effect of making the relative length of the light-source lighting period large can hardly be obtained.

### 7.3 Effect

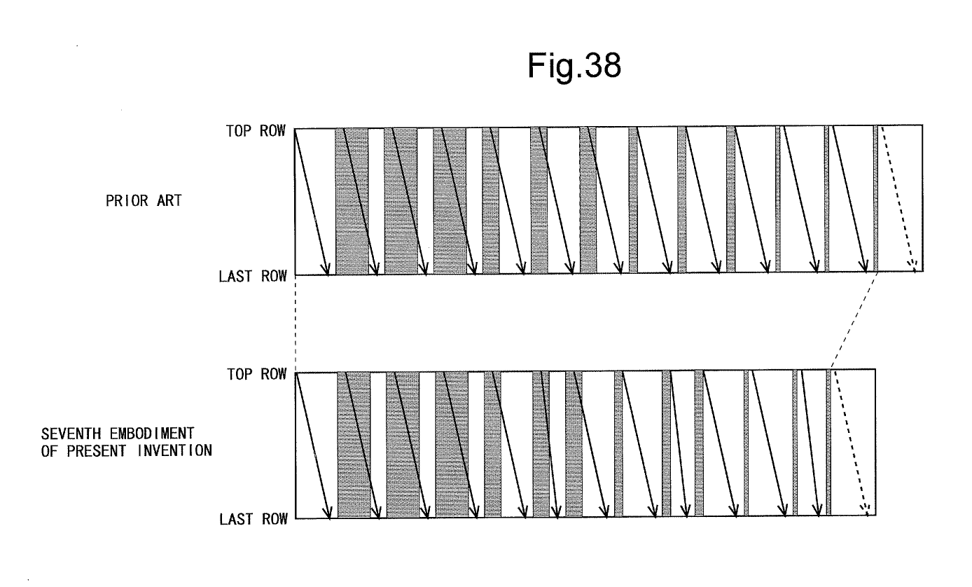

According to the present embodiment, in the DMD projector that is the image display device that performs the binary control, data-writing for display in some blue field is performed in two rows at a time. Hence, as shown in FIG. 38, the length of one frame in the present embodiment is shorter than that of one frame in the prior art. That is, the relative length of the light-source lighting period with respect to the length of one frame is larger than before. Therefore, the number of light sources to be installed in the DMD projector in order to obtain desired display brightness can be made smaller than before. This results in achievement of cost reduction regarding installation of the light source, space saving, weight reduction, and the like.

In addition, it is also possible to make the length of one frame the same as before, and make the length of each light-source lighting period larger than before. Further, when the length of one frame is made the same as before and the length of each light-source lighting period is made the same as before, the time longer than before can be allocated to the data writing period. In this case, the resolution can be made higher than before by making the number of rows of pixels larger than before.

### 8. Eighth Embodiment

### 8.1 Summary

An eighth embodiment of the present invention is described. Note that in the following description, a ratio of brightness to be displayed in each field with respect to the whole brightness is referred to as a “brightness weight.” For example, when focusing on the red field group, the field with the largest brightness weight is the field R8, and the field with the smallest brightness weight is the field R1. In the seventh embodiment, in consideration of the sensitivity of the human eyes to colors, the high-speed writing mode has been employed to the data writing processing for display in some blue field. In contrast, in the present embodiment, a field to which the high-speed writing mode is employed is determined in consideration of the brightness weight. More specifically, the high-speed writing mode is employed to the data writing processing for display in a field with a relatively small brightness weight for each color so as to prevent great deterioration in image quality.

### 8.2 Drive Method

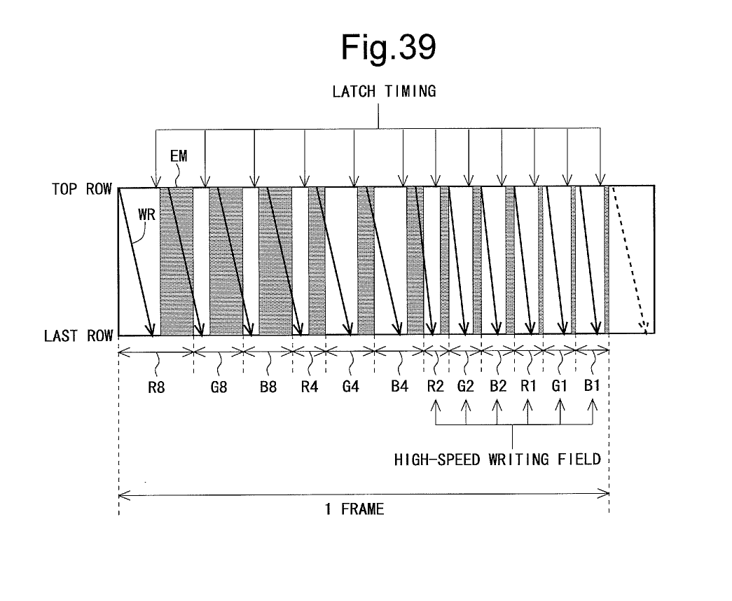

FIG. 39 is a diagram for describing a drive method in the present embodiment. As shown in FIG. 39, in the present embodiment, concerning every color, the high-speed writing mode is employed to the data writing processing for display in a field with the smallest brightness weight and the data writing processing for display in a field with the second smallest brightness weight. When focusing on the high-speed writing field, concerning the data writing processing for display in a field with each brightness weight of each color, for example, the data writing processing in the first high-speed writing mode is performed as shown in FIG. 8 in the odd-numbered frame, and the data writing processing in the second high-speed writing mode is performed as shown in FIG. 9 in the even-numbered frame. When focusing on the normal writing field, concerning the data writing processing for display in the field with each brightness weight of each color, the data writing processing is performed as shown in FIG. 7 in all the frames.

### 8.3 Effect

According to the present embodiment, in the DMD projector that is the image display device that performs the binary control, data-writing for display in a field with a relatively small brightness weight is performed in two rows at a time. Hence a similar effect to that in the seventh embodiment is obtained so as to prevent great deterioration in image quality.

### 8.4 Modified Example

Although the eighth embodiment has been described taking the DMD projector as the example, the drive method described in the eighth embodiment is also applicable to a plasma display device. This is described hereinafter. In the plasma display device, data is written into a pixel portion for red, a pixel portion for green, and a pixel portion for blue at the same timing. Therefore, differently from the above-described DMD projector, one frame includes a plurality of fields that are common among all the colors. More specifically, one frame includes a plurality of fields with mutually different brightness weights. In such a configuration, the high-speed writing mode may be employed to the data writing processing for display in a field with a relatively small brightness weight. For example, when one frame includes ten fields with mutually different brightness weights, the high-speed writing mode may be employed to the data writing processing for display in a field with the smallest brightness weight and the data writing processing for display in a field with the second smallest brightness weight.

### 9. Ninth Embodiment

### 9.1 Summary

A ninth embodiment of the present invention is described. In the present embodiment, a field to which the high-speed writing mode is employed is determined in consideration of both the sensitivity of the human eyes to colors and the brightness weight. Therefore, concerning a color to which the sensitivity (visibility) is high, the high-speed writing mode is employed only to the data writing processing for display in a field with a small brightness weight, and concerning a color to which the sensitivity (visibility) is low, the high-speed writing mode is employed not only to the data writing processing for display in the field with a small brightness weight, but also to the data writing processing for display in a field with a relatively large brightness weight.

### 9.2 Drive Method

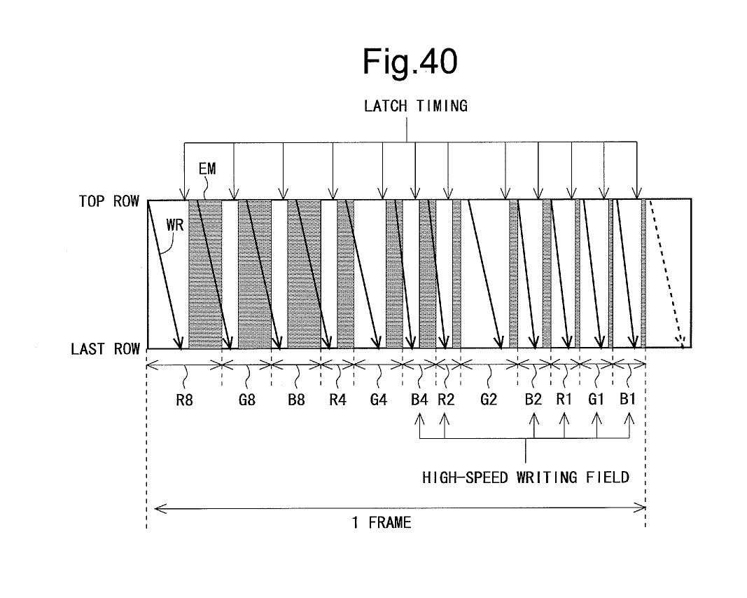

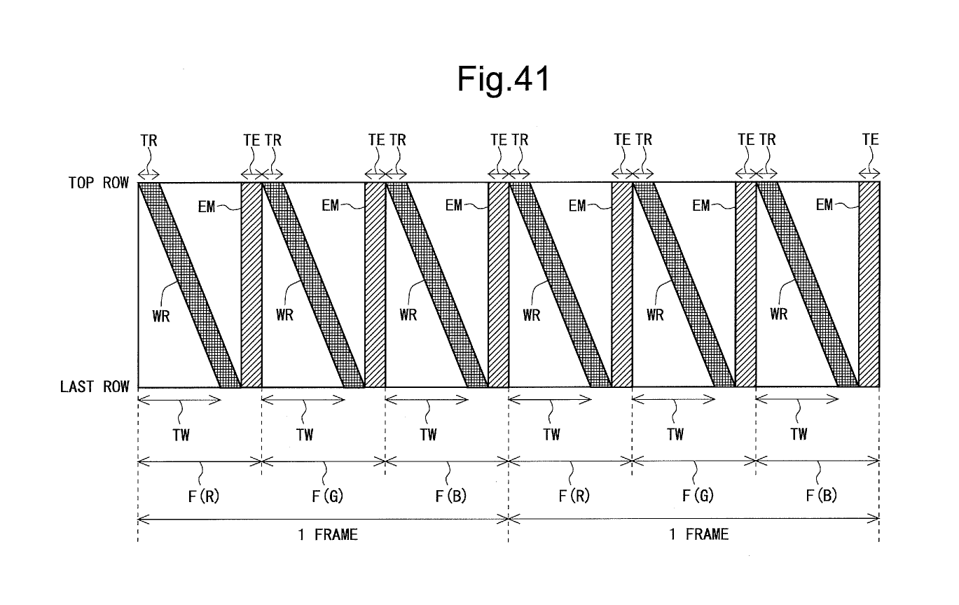

FIG. 40 is a diagram for describing a drive method in the present embodiment. As shown in FIG. 40, in the present embodiment, the high-speed writing mode is employed to the data writing processing for display in the field B4, the field R2, the field B2, the field R1, the field G1, and the field B1. As described above, as to green, to which the sensitivity (visibility) is the highest of the three primary colors, only one field is set as the high-speed writing field, and as to red, to which the sensitivity (visibility) is the second highest, two fields are set as the high-speed writing fields, and as to blue, to which the sensitivity (visibility) is the lowest, three fields are set as the high-speed writing fields.

### 9.3 Effect

According to the present embodiment, in the DMD projector that is the image display device that performs the binary control, a field to which the high-speed writing mode is employed is determined in consideration of both the sensitivity of the human eyes to colors and the brightness weight. Hence the relative length of the light-source lighting period with respect to the length of one frame can be made effectively larger without causing deterioration in image quality. Therefore, the number of light sources to be installed in the DMD projector in order to obtain desired display brightness can be more reliably made smaller than before. This results in achievement of cost reduction regarding installation of the light source, space saving, weight reduction, and the like, in a more effective manner.

### DESCRIPTION OF REFERENCE CHARACTERS

4: PIXEL PORTION

11: FRAME DATA MEMORY

12: FIELD DATA GENERATION PORTION

13: WRITING MODE CONTROL PORTION

14: EMISSION COLOR SELECTION PORTION

100: SIGNAL PROCESSING CIRCUIT

200: SOURCE DRIVER

210: GATE DRIVER

300: LIGHT EMISSION DEVICE DRIVER

310: LIGHT EMISSION DEVICE (LIGHT SOURCE)

320: OPTICAL MECHANISM PORTION

400: DISPLAY PORTION

500: DATA WRITING PORTION

510: ROW SELECTION PORTION

600: DMD (DIGITAL MIRROR DEVICE)

1: An image display device comprising:
light sources of a plurality of colors; and
pixel portions of a plurality of rows by a plurality of columns that are irradiated with light emitted from the light sources of the plurality of colors,
the image display device configured to display a color image by dividing one frame into a plurality of fields and by switching the color of the light source to be lighted every time the field is switched,
wherein, as modes during writing of data into the pixel portions of the plurality of rows by the plurality of columns, a normal writing mode for writing data into one row at a time and a high-speed writing mode for writing data having the same value into a plurality of rows at a time for each column are prepared, and
data writing processing in the high-speed writing mode is performed in at least one of the fields, and data writing processing in the normal writing mode is performed in the other fields.

2: The image display device according to claim 1, wherein
one frame includes a red field for displaying a red screen, a green field for displaying a green screen, and a blue field for displaying a blue screen, and
in the blue field, the data writing processing in the high-speed writing mode is performed.

3. (canceled)

4: The image display device according to claim 1, wherein
one frame includes a red field for displaying a red screen, a green field for displaying a green screen, a blue field for displaying a blue screen, and a white field for displaying a white screen, and
in the white field, the data writing processing in the normal writing mode is performed.

5: The image display device according to claim 1, wherein
one frame includes a red field for displaying a red screen, a green field for displaying a green screen, a blue field for displaying a blue screen, and a yellow field for displaying a yellow screen, and
in the yellow field, the data writing processing in the normal writing mode is performed.

6. (canceled)

7: The image display device according to claim 1, wherein
when focusing on a field in which the data writing processing in the high-speed writing mode is performed, a combination of a plurality of rows, into which data having the same value is written, is different between a preceding frame of two consecutive frames and a subsequent frame of the two consecutive frames.

8: The image display device according to claim 1, wherein
when a set of rows, into which data is written at the same timing when the data writing processing in the high-speed writing mode is performed, is defined as a group, when the data writing processing in the high-speed writing mode is performed, data having the same value as that of data in a preceding group of two adjacent groups is written into a subsequent group of the two adjacent groups in at least some period of a latter half of a period in which data is written into the preceding group, and
when the data writing processing in the normal writing mode is performed, data having the same value as that of data in a preceding row of two adjacent rows is written into a subsequent row of the two adjacent rows in at least some period of a latter half of a period in which data is written into the preceding row.

9. (canceled)

10: An image display device comprising:
light sources of a plurality of colors; and
pixel portions of a plurality of rows by a plurality of columns that are irradiated with light emitted from the light sources of the plurality of colors,
the image display device configured to display a color image by dividing one frame into a plurality of fields and by switching the color of the light source to be lighted every time the field is switched,
wherein, in all the fields, data having the same value is written into a plurality of rows at a time for each column, with respect to the pixel portions of the plurality of rows by the plurality of columns.

11: The image display device according to claim 10, wherein
one frame includes a red field for displaying a red screen, a green field for displaying a green screen, and a blue field for displaying a blue screen, and
the green field appears a plurality of times within one frame.

12: The image display device according to claim 11, wherein, when focusing on the plurality of times of the green fields that appear within one field, a combination of a plurality of rows, into which data having the same value is written, is different each time of the green field.

13: The image display device according to claim 10, wherein
one frame includes a red field for displaying a red screen, a green field for displaying a green screen, a blue field for displaying a blue screen, and a white field for displaying a white screen, and
the white field appears a plurality of times within one frame.

14: The image display device according to claim 10, wherein
one frame includes a red field for displaying a red screen, a green field for displaying a green screen, a blue field for displaying a blue screen, and a yellow field for displaying a yellow screen, and
the yellow field appears a plurality of times within one frame.

15: The image display device according to claim 14, wherein at least one of the yellow fields that appears the plurality of times within one frame is provided between the green field and the red field.

16: The image display device according to claim 10, wherein
when focusing on at least one field, a combination of a plurality of rows, into which data having the same value is written, is different between a preceding frame of two consecutive frames and a subsequent frame of the two consecutive frames.

17: The image display device according to claim 10, wherein, when a set of rows, into which data is written at the same timing, is defined as a group, data having the same value as that of data in a preceding group of two adjacent groups is written into a subsequent group of the two adjacent groups in at least some period of a latter half of a period in which data is written into the preceding group.

18. (canceled)

19: An image display device comprising:
light sources of a plurality of colors; and
pixel portions of a plurality of rows by a plurality of columns that are irradiated with light emitted from the light sources of the plurality of colors,
the image display device having one frame formed of one or more field groups each including a plurality of fields, and configured to perform gradation display by controlling an on/off state of each of the pixel portions in each of the fields,
wherein, as modes during writing of data into the pixel portions of the plurality of rows by the plurality of columns, a normal writing mode for writing data into one row at a time and a high-speed writing mode for writing data having the same value into a plurality of rows at a time for each column are prepared,
each of the pixel portions is configured such that binary data indicating the on/off state can be written thereinto, and
the high-speed writing mode is employed to data writing processing for display in at least one of the fields, and the normal writing mode is employed to data writing processing for display in the other fields.

20: The image display device according to claim 19, wherein
one frame includes a red field group for displaying a red screen, a green field group for displaying a green screen, and a blue field group for displaying a blue screen, and
the high-speed writing mode is employed to data writing processing for display in at least one field of the blue field group.

21: The image display device according to claim 19, wherein each of the field groups includes N (N is an integer not smaller than 2) fields having light-source lighting periods with mutually different lengths.

22: The image display device according to claim 21, wherein
when focusing on each of the field groups,
the normal writing mode is employed to data writing processing for display in a field with the first to Kth longest (K is an integer not larger than N−1) light-source lighting period, and the high-speed writing mode is employed to data writing processing for display in the other fields, and
the value of K is the same in all the field groups.

23: The image display device according to claim 21, wherein
when focusing on each of the field groups,
the normal writing mode is employed to data writing processing for display in a field with the first to Kth longest (K is an integer not larger than N−1) light-source lighting period, and the high-speed writing mode is employed to data writing processing for display in the other fields, and
the value of K can be different in each of the field groups.

24: The image display device according to claim 19, wherein
concerning the data writing processing in the high-speed writing mode for display in at least one field, a combination of a plurality of rows, into which data having the same value is written, is different between a preceding frame of two consecutive frames and a subsequent frame of the two consecutive frames.

25. (canceled)
